(19) United States
(12) Patent Application Publication
(10) Pub. No.: US 2003/0016424 A1
(43) Pub. Date: Jan. 23, 2003

(54) Broad-band FM demodulator, optical receiving apparatus using broad-band FM demodulator, and optical transmission system

(76) Inventor: Kazuhiro Nojima, Yokohama-shi (JP)

Correspondence Address: LOUIS WOO, LAW OFFICE OF LOUIS WOO, 1901 NORTH FORT MYER DRIVE, SUITE 501, ARLINGTON, VA, 22209, US

(21) Appl. No.: 10/164,715

(22) Filed: Jun. 10, 2002

(30) Foreign Application Priority Data
Jun. 12, 2001 (JP) 2001-176676

(51) Int. Cl. H04B 10/06

(52) U.S. Cl. 359/189

(57) ABSTRACT

There is disclosed a constitution in an FM demodulator of a delay detection system for solving a problem that a demodulated signal is distorted because of a dragging or undershoot in an output pulse of an AND gate for outputting a logical product, the FM demodulator comprising: a limiter circuit which responds to an inputted FM signal; a delay circuit which delays one of two outputs; an AND gate into which another output of the limiter circuit and an output of the delay circuit are inputted; and a low-pass filter 4 into which an output of the AND gate is inputted, wherein tilted frequency characteristics are imparted to group delay of the delay circuit, the group delay frequency characteristics impart nonlinearity to fV characteristics, the fV characteristics are thereby inversely corrected, and linearity is improved.

### BACKGROUND OF THE INVENTION

1. Field of the Invention

One mode of the present invention relates to a broad-band FM demodulator which converts multi-channel AM image signals, digital image signals, and the like together to FM signals having a broad band of several GHz, which constitutes an optical transmission system and a part of the optical transmission system and which uses a delay detection method of converting the broad-band FM signals to the multi-channel AM signals and digital image signals.

2. Prior Art

A constitution example of a conventional delay detection type broad-band FM demodulator disclosed in Japanese Patent Application Laid-Open Nos. H01-238307 and H10-190357 is schematically shown in FIG. 2.

The FM demodulator includes: a limiter circuit 1 for converting an inputted FM signal to a pulse; a delay circuit 2 for delaying one of signals outputted from the limiter circuit 1; an AND gate 3 which outputs a logical product of the signal outputted from the limiter circuit and a signal obtained by delaying the output signal; and a low-pass filter 4 which obtains a demodulated signal from an output of the AND gate 3. Additionally, the limiter circuit is described as a circuit which outputs two output signals consisting of non-reverse and reverse outputs, but is equivalent to a circuit including an inverter for obtaining a reverse output signal from a single output signal.

In the FM demodulator, the inputted FM signal is converted to a pulse by the limiter circuit 1, one of outputs of the limiter circuit 1 is inputted into the AND gate 3 as such, and the other signal logically reversed and outputted by the limiter circuit 1 is delayed by the delay circuit 2 and subsequently inputted into the AND gate 3. When the output of the AND gate 3 is passed through the low-pass filter 4, the FM signal is demodulated.

Waveforms of stages of the FM demodulator of a conventional delay detection system are shown in FIGS. 3A to 3E. FIG. 3A shows an inputted sine-wave signal having a period T (frequency f=1/T), FIGS. 3B, 3C show the input of the AND gate 3, and FIG. 3D shows the output of the AND gate 3. The signal of FIG. 3C is delayed from the signal of FIG. 3B by a time of a delay amount T of the delay circuit 2. When a logical product of the signals of FIGS. 3B and 3C is obtained by the AND gate, a signal becoming high for a time t as shown in FIG. 3D is outputted as shown in FIG. 3D. Furthermore, an output voltage Vout passed through the low-pass filter 4 is represented by the following as shown in FIG. 3E, assuming that high and low voltages of the output of the AND gate 3 are VHI, VLO.

Vout=(V_{HI}−V_{LO})×τ1T=(V_{HI}−V_{LO})×τ×f

Since VHI, VLO, τ have constant values, a relation of an input frequency f (=1/T) of the FM demodulator to the output voltage Vout (hereinafter referred to as fV characteristics) is a linear relation as shown in FIG. 3F. When the input frequency is the FM signal, FM demodulation is possible.

However, in the FM demodulator as in the conventional example, draggling or undershoot is generated in the waveform of the output of the AND gate 3 by a difference of rising and falling times of devices such as a transistor and field-effect transistor (hereinafter referred to as the FET) for use in the limiter circuit 1, delay circuit 2 and AND gate 3, and a parasitic inductance and parasitic capacity in the limiter circuit 1, delay circuit 2 and AND gate 3. In this case, nonlinearity is generated in the fV characteristics.

FIGS. 4A to 4F show the output pulses (left side: time on the abscissa, voltage on the ordinate) and fV characteristics (right side: input frequency on the abscissa, output voltage on the ordinate) of the AND gate 3 in a state in which the pulse is not deteriorated (FIGS. 4A, 4D), a case in which the pulse has a dragging (FIGS. 4B, 4E), and a case in which the pulse has an undershoot (FIGS. 4C, 4F). In FIGS. 4A to 4C, like an actual waveform, the rising and falling times are shown in the pulse. When there is no dragging or undershoot as shown in FIG. 4A, and when the frequency with the output pulses of the AND gate 3 overlapping therein is a usable band shown in the fV characteristics of FIG. 4D, a low level of the output of the AND gate 3 is constant, and therefore linear characteristics are obtained in the usable band. On the other hand, when the output pulse of the AND gate 3 has a dragging as shown in FIG. 4B, nonlinear fV characteristics first having a large tilt and a gradually reduced tilt like the fV characteristics of FIG. 4E are obtained. On the other hand, when the output pulse of the AND gate 3 has an undershoot as shown in FIG. 4C, the nonlinear fV characteristics first having a small tilt and a gradually increased tilt like the fV characteristics of FIG. 4F are obtained. With the nonlinearity as in FIGS. 4B and 4C, a distortion is generated in the output signal demodulated with respect to the input FM signal.

### SUMMARY OF THE INVENTION

The present invention has been developed to solve the above-described problem, and a first object is to provide a broad-band FM demodulator which can correct nonlinearity of fV characteristics as a relation of an input frequency to output voltage particularly of the FM demodulator, improves linearity of the fV characteristics, suppresses a mutual modulation distortion (hereinafter referred to as the distortion) generated during FM demodulation of an FM signal to a multi-channel AM image signal, digital image signal modulated by 64 QAM, and the like, and which improves transmission characteristics.

A second object of the present invention is to provide a reception apparatus and system in which the broad-band FM demodulator is constituted in an optical transmission system and thereby distortion characteristics are improved.

To achieve these objects, frequency characteristics of group delay are tilted in a broad-band FM demodulator according to one mode of the present invention, whereas the frequency characteristics of group delay are flat in a delay circuit of a conventional FM demodulator. Additionally, the tilt of the frequency characteristics herein means a tilt of a frequency characteristics curve (a curve on a graph showing a response to a frequency or a signal level).

FIGS. 5A to 5C show a case in which frequency characteristics of group delay are flat, and FIGS. 5D to 5F show a case in which the frequency characteristics of group delay of one (passed through the delay circuit) of limiter outputs are tilted. For these cases, group delay characteristics (FIGS. 5A, 5D), AND gate output pulses (FIGS. 5B, 5E), and FM demodulator fV characteristics (FIGS. 5C, 5F) are compared and shown. As shown in FIG. 5A, when the frequency characteristics of the group delay of the delay circuit are flat, two signals inputted into the AND gate deviate by t time in all frequencies and are inputted into the AND gate. On the other hand, as shown in FIG. 5D, the frequency characteristics of a delay amount are imparted to the delay circuit such that the delay amount decreases with an increase of frequency. In this case, since a frequency characteristics dependence is generated in the delay amount of the signal passed through the delay circuit, the delay difference of two signals inputted into the AND gate differs with the frequency (τ and τ′ of FIG. 5D). In this case, a pulse width of AND output having been constant in FIG. 5B differs with the input frequency in FIG. 5B. As shown by a dotted line in the drawing with a low frequency and a solid line in the drawing with a high frequency, when the frequency increases, the pulse width is reduced. Therefore, for the fV characteristics (FIG. 5C), the fV characteristics are largely tilted with the low frequency, and the tilt is reduced with the high frequency. That is, when the frequency characteristics of group delay of the delay circuit are changed, nonlinearity can be generated in the fV characteristics. Moreover, when the tilt of the frequency characteristics of group delay of the delay circuit (FIG. 5D) is reversed, the pulse width of the AND gate output is small with the low frequency, and large with the high frequency in the fV characteristics warped in a reverse direction as shown in FIG. 5F.

Therefore, in the broad-band FM demodulator according to the present invention, the change of the fV characteristics obtained by tilting the frequency characteristics of group delay in the delay circuit is used. When the pulse of the AND gate output has a dragging or undershoot as the problems of a conventional FM demodulator, the nonlinearity of the fV characteristics is compensated for as a characteristic. FIGS. 6A to 6C show group delay characteristics (FIG. 6A), AND gate output waveform (FIG. 6B), and fV characteristics (FIG. 6C) in a case in which there is an undershoot and the group delay characteristics of the delay circuit are tilted so as to compensate for the nonlinearity of the fV characteristics. As shown in FIG. 6A, when the frequency increases, the delay difference of two signals inputted into the AND gate is reduced. Then, as shown in FIG. 6B, when the frequency increases, the pulse width is reduced. Therefore, for the fV characteristics (FIG. 6C), when the frequency characteristics of group delay are tilted in the delay circuit, nonlinearity of fV characteristics generated by the undershoot is reverse to the nonlinearity of fV characteristics by the frequency characteristics of group delay of the delay circuit. As compared with a case in which the group delay is flat (dot line of FIG. 6C), the linearity of the fV characteristics can be improved as shown by a solid line of FIG. 6C. Here, when the tilt of the frequency characteristics of group delay in the delay circuit is changed, a correction amount of nonlinearity can be adjusted. Furthermore, when the tilt of the frequency characteristics of group delay is reversed, and when the pulse of the AND gate output has a dragging, the fV characteristics are similarly corrected and linearity can be improved. Moreover, also when the frequency characteristics are imparted to the group delay of the signal inputted into the AND gate and not passed through the delay circuit without imparting the frequency characteristics to the group delay in the delay circuit, similar effects are obtained.

As described above, according to the present invention, the frequency characteristics are imparted to the delay difference of two signals inputted into the AND gate in the conventional delay detection type FM demodulator, the delay difference is used and the linearity of the input frequency to the output voltage is improved. Thereby, a mutual modulation distortion generated during the FM demodulation of the broad-band FM signal to the multi-channel AM image signal or digital image signal is suppressed, and transmission characteristics can be improved.

According to one aspect of the present invention, there is provided a broad-band FM demodulator comprising: a limiter circuit which limits an amplitude of an inputted FM signal and generates pulsed non-reverse and reverse FM signals; a delay circuit which delays one of the reverse and non-reverse FM signals; multiplication means for outputting a logical product of the other of the reverse and non-reverse FM signals and a delayed FM signal as an output of the delay circuit; and a low-pass filter which obtains a demodulated signal from an output of the multiplication means,

wherein tilted frequency characteristics are imparted to group delay of the delay circuit.

According to the constitution, when the dragging or undershoot is generated in the multiplication means output of the broad-band FM demodulator and linearity of fV characteristics is deteriorated, a delay difference of two signals inputted into the multiplication means is changed in accordance with the frequency, the linearity of input/output characteristics of the broad-band FM demodulator is corrected, and thereby the linearity of the broad-band FM demodulator can be improved.

According to another aspect of the present invention, there is provided a broad-band FM demodulator comprising: a limiter circuit which limits an amplitude of an inputted FM signal and generates pulsed non-reverse and reverse FM signals; a delay circuit which delays one of the reverse and non-reverse FM signals; multiplication means for outputting a logical product of the other of the reverse and non-reverse FM signals and a delayed FM signal as an output of the delay circuit; and a low-pass filter which obtains a demodulated signal from an output of the multiplication means, the demodulator further comprising:

a group delay frequency characteristics tilt circuit which imparts tilted frequency characteristics to group delay of the delayed FM signal as the output of the delay circuit, wherein an output of the group delay frequency characteristics tilt circuit is supplied as the delayed FM signal to the multiplication means.

According to the constitution, when the dragging or undershoot is generated in the multiplication means output of the broad-band FM demodulator and linearity of fV characteristics is thereby deteriorated, the delay difference of two signals inputted into the multiplication means is changed in accordance with the frequency, the linearity of the input/output characteristics of the broad-band FM demodulator is corrected, and thereby the linearity of the broad-band FM demodulator can be improved.

According to another aspect of the present invention, there is provided a broad-band FM demodulator comprising: a limiter circuit which limits an amplitude of an inputted FM signal and generates pulsed non-reverse and reverse FM signals; a delay circuit which delays one of the reverse and non-reverse FM signals; multiplication means for outputting a logical product of the other of the reverse and non-reverse FM signals and a delayed FM signal as an output of the delay circuit; and a low-pass filter which obtains a demodulated signal from an output of the multiplication means, the demodulator further comprising:

a group delay frequency characteristics tilt circuit which imparts tilted frequency characteristics to group delay of the other of the reverse and non-reverse FM signals, wherein an output of the group delay frequency characteristics tilt circuit is supplied as the other of the reverse and non-reverse FM signals to the multiplication means.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency, the linearity of the input/output characteristics of the broad-band FM demodulator is corrected, and thereby the linearity of the broad-band FM demodulator can be improved.

According to another aspect of the present invention, there is provided a broad-band FM demodulator comprising: a limiter circuit which limits an amplitude of an inputted FM signal and generates pulsed non-reverse and reverse FM signals; a delay circuit which delays one of the reverse and non-reverse FM signals; multiplication means for outputting a logical product of the other of the reverse and non-reverse FM signals and a delayed FM signal as an output of the delay circuit; and a low-pass filter which obtains a demodulated signal from an output of the multiplication means, the demodulator further comprising:

a group delay frequency characteristics tilt circuit which imparts tilted frequency characteristics to group delay of the delay circuit and to the group delay of the other of the reverse and non-reverse FM signals, wherein an output of the group delay frequency characteristics tilt circuit is supplied as the other of the reverse and non-reverse FM signals to the multiplication means.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency, the linearity of the input/output characteristics of the broad-band FM demodulator is corrected, and thereby the linearity of the broad-band FM demodulator can be improved.

According to another aspect of the present invention, there is provided a broad-band FM demodulator comprising: a limiter circuit which limits an amplitude of an inputted FM signal and generates pulsed non-reverse and reverse FM signals; a delay circuit which delays one of the reverse and non-reverse FM signals; multiplication means for outputting a logical product of the other of the reverse and non-reverse FM signals and a delayed FM signal as an output of the delay circuit; and a low-pass filter which obtains a demodulated signal from an output of the multiplication means, the demodulator further comprising:

a first group delay frequency characteristics tilt circuit which imparts tilted frequency characteristics to group delay of the other of the reverse and non-reverse FM signals; and a second group delay frequency characteristics tilt circuit which imparts the tilted frequency characteristics to the group delay of the delay circuit, wherein an output of the first group delay frequency characteristics tilt circuit as the other of the reverse and non-reverse FM signals and an output of the second group delay frequency characteristics tilt circuit as the delayed FM signal are supplied to the multiplication means.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency, the linearity of the input/output characteristics of the broad-band FM demodulator is corrected, and thereby the linearity of the broad-band FM demodulator can be improved.

In one aspect of the present invention, the above-described broad-band FM demodulator further comprises a function of changing the tilt of the tilted frequency characteristics imparted to the group delay of the delay circuit.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency. Furthermore, since the delay difference can be adjusted, the linearity of the input/output characteristics of the broad-band FM demodulator can be corrected with good precision, and the linearity of the broad-band FM demodulator can be improved. In one aspect of the present invention, the above-described broad-band FM demodulator further comprises:

a band pass filter which extracts a mutual modulation distortion component of a signal outputted from the low-pass filter;

a power detection circuit which detects a level of the mutual modulation distortion component extracted by the band pass filter; and

a control circuit which controls the group delay of the delay circuit so as to minimize a mutual modulation distortion detection level.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency. Furthermore, the delay difference is automatically controlled so as to minimize the distortion of the FM demodulated signal. Therefore, even when the linearity of the broad-band FM demodulator is changed in accordance with temperature, the linearity of the input/output characteristics of the delay amount broad-band FM demodulator can automatically be corrected, and the linearity of the broad-band FM demodulator can be improved.

In one aspect of the present invention, the above-described broad-band FM demodulator further comprises: a function of changing the tilt of the tilted frequency characteristics imparted to the group delay of the group delay frequency characteristics tilt circuit which responds to the delayed FM signal.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency. Furthermore, since the delay difference can be adjusted, the linearity of the input/output characteristics of the broad-band FM demodulator can be corrected with good precision, and the linearity of the broad-band FM demodulator can be improved.

In one aspect of the present invention, the above-described broad-band FM demodulator further comprises:

a band pass filter which extracts a mutual modulation distortion component of a signal outputted from the low-pass filter;

a power detection circuit which detects a level of the mutual modulation distortion component extracted by the band pass filter; and

a control circuit which controls the group delay of the group delay frequency characteristics tilt circuit so as to minimize a mutual modulation distortion detection level.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency. Furthermore, the delay difference is automatically controlled so as to minimize the distortion of the FM demodulated signal. Therefore, even when the linearity of the broad-band FM demodulator is changed in accordance with temperature, the linearity of the input/output characteristics of the broad-band FM demodulator can automatically be corrected, and the linearity of the broad-band FM demodulator can be improved.

In one aspect of the present invention, the above-described broad-band FM demodulator further comprises: a function of changing the tilt of the tilted frequency characteristics imparted to the group delay of the delay circuit; and a function of changing the frequency characteristics of the group delay in the group delay frequency characteristics tilt circuit which responds to the other of the reverse and non-reverse FM signals.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency. Furthermore, since the delay difference can be adjusted, the linearity of the input/output characteristics of the broad-band FM demodulator can be corrected with good precision, and the linearity of the broad-band FM demodulator can be improved.

In one aspect of the present invention, the above-described broad-band FM demodulator further comprises:

a band pass filter which includes a function of changing the tilt of the tilted frequency characteristics imparted to the group delay of the delay circuit, and a function of changing the tilt of the frequency characteristics of the group delay in the group delay frequency characteristics tilt circuit responding to the other of the reverse and non-reverse FM signals, and extracts a mutual modulation distortion component of a signal outputted from the low-pass filter;

a power detection circuit which detects a level of the mutual modulation distortion component extracted by the band pass filter; and

a control circuit which controls the group delay of the delay circuit and the group delay in the group delay frequency characteristics tilt circuit so as to minimize a mutual modulation distortion detection level.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency. Furthermore, the delay difference is automatically controlled so as to minimize the distortion of the FM demodulated signal. Therefore, even when the linearity of the broad-band FM demodulator is changed in accordance with temperature, the linearity of the input/output characteristics of the broad-band FM demodulator can automatically be corrected, and the linearity of the broad-band FM demodulator can be improved.

In one aspect of the present invention, the above-described broad-band FM demodulator further comprises:

a band pass filter which includes a function of changing the tilt of the tilted frequency characteristics imparted to the group delay of the first group delay frequency characteristics tilt circuit responding to the delayed FM signal, and a function of changing the tilt of the frequency characteristics of the group delay in the second group delay frequency characteristics tilt circuit responding to the other of the reverse and non-reverse FM signals, and extracts a mutual modulation distortion component of a signal outputted from the low-pass filter;

a power detection circuit which detects a level of the mutual modulation distortion component extracted by the band pass filter; and

a control circuit which controls the group delay of the first and second group delay frequency characteristics tilt circuits so as to minimize a mutual modulation distortion detection level.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency. Furthermore, the delay amount is automatically controlled so as to minimize the distortion of the FM demodulated signal. Therefore, even when the linearity of the broad-band FM demodulator is changed in accordance with temperature, the linearity of the input/output characteristics of the broad-band FM demodulator can automatically be corrected, and the linearity of the broad-band FM demodulator can be improved.

According to one aspect of the present invention, there is provided the above-described broad-band FM demodulator wherein the delay circuit is constituted of a circuit connected in one stage or a multiplicity of stages in series, each circuit including:

first and second input terminals into which input signals constituting a differential pair are inputted;

first and second field-effect transistors whose gates are connected to the first and second input terminals;

first and second load resistors which connect drains of the first and second field-effect transistors to a power source Vdd on a positive side;

a third field-effect transistor whose drain is connected to sources of the first and second field-effect transistors and whose source is connected to a power source Vss on a negative side;

fourth and fifth field-effect transistors whose gates are connected to the drains of the first and second field-effect transistors and whose drains are connected to the power source Vdd on the positive side;

first and second diodes connected to the sources of the fourth and fifth field-effect transistors;

sixth and seventh field-effect transistors whose drains are connected to other ends of the first and second diodes and whose sources are connected to the power source Vss on the negative side;

first and second output terminals which output differential outputs from the other ends of the first and second diodes;

a predetermined power source which supplies a constant voltage to gates of the third, sixth and seventh field-effect transistors serving as a constant current drive circuit;

coils inserted between the predetermined power source and the gates of the third, sixth and seventh field-effect transistors; and

a capacitor connected between the predetermined power source and the power source Vss on the negative side.

According to the constitution, the delay circuit is constituted of a basic differential circuit and source follower. When the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the delay circuit is constituted of a circuit connected in one stage or a multiplicity of stages in series, each circuit including:

first and second input terminals into which input signals constituting a differential pair are inputted;

first and second field-effect transistors whose gates are connected to the first and second input terminals;

first and second load resistors which connect drains of the first and second field-effect transistors to a power source Vdd on a positive side;

a third field-effect transistor whose drain is connected to sources of the first and second field-effect transistors and whose source is connected to a power source Vss on a negative side;

fourth and fifth field-effect transistors whose gates are connected to the drains of the first and second field-effect transistors and whose drains are connected to the power source Vdd on the positive side;

first and second diodes connected to the sources of the fourth and fifth field-effect transistors;

sixth and seventh field-effect transistors whose drains are connected to other ends of the first and second diodes and whose sources are connected to the power source Vss on the negative side;

first and second output terminals which output differential outputs from the other ends of the first and second diodes;

a predetermined power source which supplies a constant voltage to gates of the third, sixth and seventh field-effect transistors serving as a constant current drive circuit;

coils inserted between the predetermined power source and the gates of the third, sixth and seventh field-effect transistors; and

a capacitor connected between the gates of the third, sixth and seventh field-effect transistors and the power source Vss on the negative side.

According to the constitution, the delay circuit is constituted of the basic differential circuit and source follower. When the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the delay circuit is constituted of a circuit connected in one stage or a multiplicity of stages in series, each circuit including:

first and second input terminals into which input signals constituting a differential pair are inputted;

first and second field-effect transistors whose gates are connected to the first and second input terminals;

first and second load resistors which connect drains of the first and second field-effect transistors to a power source Vdd on a positive side;

a third field-effect transistor whose drain is connected to sources of the first and second field-effect transistors and whose source is connected to a power source Vss on a negative side;

fourth and fifth field-effect transistors whose gates are connected to the drains of the first and second field-effect transistors and whose drains are connected to the power source Vdd on the positive side;

first and second diodes connected to the sources of the fourth and fifth field-effect transistors;

sixth and seventh field-effect transistors whose drains are connected to other ends of the first and second diodes and whose sources are connected to the power source Vss on the negative side;

first and second output terminals which output differential outputs from the other ends of the first and second diodes;

a predetermined power source which supplies a constant voltage to gates of the third, sixth and seventh field-effect transistors serving as a constant current drive circuit;

a series circuit of a third resistor and first capacitor inserted between the gate of the fourth field-effect transistor and the power source Vdd on the positive side or the power source Vss on the negative side; and

a series circuit of a fourth resistor and second capacitor inserted between the gate of the fifth field-effect transistor and the power source Vdd on the positive side or the power source Vss on the negative side.

According to the constitution, the delay circuit is constituted of the basic differential circuit and source follower. When the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the delay circuit is constituted of a circuit connected in one stage or a multiplicity of stages in series, each circuit including:

first and second input terminals into which input signals constituting a differential pair are inputted;

first and second field-effect transistors whose gates are connected to the first and second input terminals;

first and second load resistors which connect drains of the first and second field-effect transistors to a power source Vdd on a positive side;

a third field-effect transistor whose drain is connected to sources of the first and second field-effect transistors and whose source is connected to a power source Vss on a negative side;

fourth and fifth field-effect transistors whose gates are connected to the drains of the first and second field-effect transistors and whose drains are connected to the power source Vdd on the positive side;

first and second diodes connected to the sources of the fourth and fifth field-effect transistors;

sixth and seventh field-effect transistors whose drains are connected to other ends of the first and second diodes and whose sources are connected to the power source Vss on the negative side;

first and second output terminals which output differential outputs from the other ends of the first and second diodes;

a predetermined power source which supplies a constant voltage to gates of the third, sixth and seventh field-effect transistors serving as a constant current drive circuit;

a series circuit of a third resistor and first coil inserted between the gate of the fourth field-effect transistor and the power source Vdd on the positive side or the power source Vss on the negative side; and

a series circuit of a fourth resistor and second coil inserted between the gate of the fifth field-effect transistor and the power source Vdd on the positive side or the power source Vss on the negative side.

According to the constitution, the delay circuit is constituted of the basic differential circuit and source follower. When the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the delay circuit is constituted of a circuit connected in one stage or a multiplicity of stages in series, each circuit including:

first and second input terminals into which input signals constituting a differential pair are inputted;

first and second field-effect transistors whose gates are connected to the first and second input terminals;

first and second load resistors which connect drains of the first and second field-effect transistors to a power source Vdd on a positive side;

a third field-effect transistor whose drain is connected to sources of the first and second field-effect transistors and whose source is connected to a power source Vss on a negative side;

fourth and fifth field-effect transistors whose gates are connected to the drains of the first and second field-effect transistors and whose drains are connected to the power source Vdd on the positive side;

first and second diodes connected to the sources of the fourth and fifth field-effect transistors;

sixth and seventh field-effect transistors whose drains are connected to other ends of the first and second diodes and whose sources are connected to the power source Vss on the negative side;

first and second output terminals which output differential outputs from the other ends of the first and second diodes;

a predetermined power source which supplies a constant voltage to gates of the third, sixth and seventh field-effect transistors serving as a constant current drive circuit;

first and second capacitors whose ends are connected to gates of the fourth and fifth field-effect transistors;

third and fourth resistors inserted between the other ends of the first and second capacitors and the positive-side power source Vdd; and

eighth and ninth field-effect transistors whose drains are connected to the third and fourth resistors, whose sources are connected to the negative-side power source Vss and whose gates are connected to each other.

According to the constitution, the delay circuit is constituted of the basic differential circuit and source follower. When the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the delay circuit is constituted of a circuit connected in one stage or a multiplicity of stages in series, each circuit including:

first and second input terminals into which input signals constituting a differential pair are inputted;

first and second field-effect transistors whose gates are connected to the first and second input terminals;

first and second load resistors which connect drains of the first and second field-effect transistors to a power source Vdd on a positive side;

a third field-effect transistor whose drain is connected to sources of the first and second field-effect transistors and whose source is connected to a power source Vss on a negative side;

fourth and fifth field-effect transistors whose gates are connected to the drains of the first and second field-effect transistors and whose drains are connected to the power source Vdd on the positive side;

first and second diodes connected to the sources of the fourth and fifth field-effect transistors;

sixth and seventh field-effect transistors whose drains are connected to other ends of the first and second diodes and whose sources are connected to the power source Vss on the negative side;

first and second output terminals which output differential outputs from the other ends of the first and second diodes;

a predetermined power source which supplies a constant voltage to gates of the third, sixth and seventh field-effect transistors serving as a constant current drive circuit;

a series circuit of a first coil and third resistor and a series circuit of a second coil and fourth resistor whose ends are connected to the gates of the fourth and fifth field-effect transistors; and

eighth and ninth field-effect transistors whose drains are connected to the other ends of the series circuit of the first coil and third resistor and the series circuit of the second coil and fourth resistor, whose sources are connected to the negative-side power source Vss and whose gates are connected to each other.

According to the constitution, the delay circuit is constituted of the basic differential circuit and source follower. When the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the group delay frequency characteristics tilt circuit to impart frequency characteristics in which a frequency characteristics curve of the group delay is tilted and to supply a control voltage to a gate of the field-effect transistor so that the tilted frequency characteristics can be changed is realized by a circuit connected in one stage or a multiplicity of stages in series, each circuit including:

a capacitor whose one end is connected to a signal transmission line between an input and output;

a field-effect transistor whose drain is connected to the other end of the capacitor and whose source is connected to a power source Vss on a negative side; and

a resistor inserted between the drain of the field-effect transistor and a power source Vdd on a positive side.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the group delay frequency characteristics tilt circuit to impart frequency characteristics in which a frequency characteristics curve of the group delay is tilted and to supply a control voltage to a gate of the field-effect transistor so that the tilted frequency characteristics can be changed is realized by a circuit connected in one stage or a multiplicity of stages in series, each circuit including:

a series circuit of a coil and resistor, whose one end is connected to a signal transmission line between an input and output; and

a field-effect transistor whose drain is connected to the other end of the series circuit of the coil and resistor and whose source is connected to a power source Vss on a negative side.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the group delay frequency characteristics tilt circuit is realized by a circuit connected in one stage or a multiplicity of stages in series, each circuit including: a series circuit of a capacitor and resistor, which is inserted between a signal transmission line between an input and output and a power source Vdd on a positive side or a power source Vss on a negative side.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, there is provided the above-described broad-band FM demodulator wherein the group delay frequency characteristics tilt circuit is realized by a circuit connected in one stage or a multiplicity of stages in series, each circuit including: a series circuit of a coil and resistor, which is inserted between a signal transmission line between an input and output and a power source Vdd on a positive side or a power source Vss on a negative side.

According to the constitution, when the dragging or undershoot is generated in the multiplication means output of the broad-band FM demodulator and the linearity of the fV characteristics is thereby deteriorated, the delay difference of two signals inputted into the multiplication means is changed in accordance with the frequency, and the linearity of the broad-band FM demodulator can be improved.

According to one aspect of the present invention, in the above-described broad-band FM demodulator, any one of an AND gate, EXOR gate, and analog multiplier is used in the multiplication means.

According to the constitution, any one of the AND gate, EXOR gate, and analog multiplier can be used as the multiplication means to constitute the broad-band FM demodulator.

According to one aspect of the present invention, in the broad-band FM demodulator, further comprising:

second multiplication means which outputs a logical product of a pulsed FM signal of reverse of the limiter circuit output and reverse signal of the delayed FM signal of the delay circuit output;

a second low-pass filter which obtains a demodulated signal from the output of the second multiplication means; and

a multiplexer which combines outputs of the first and second low-pass filters,

wherein tilted frequency characteristics are imparted to the group delay of the delay circuit.

According to the constitution, two multiplication means and two low-pass filters are disposed in the limiter circuit and one of the delay circuit, group delay frequency characteristics tilt delay circuit and group delay frequency characteristics tilt amount variable delay circuit. Even when the outputs are combined, an effect similar to that of the above-described broad-band FM demodulator is obtained, and the linearity of the broad-band FM demodulator can be improved.

According to one aspect of the present invention, in the above-described broad-band FM demodulator, any one of the limiter circuit, delay circuit, and multiplication means includes a differential circuit.

According to the constitution, the broad-band FM demodulator can obtain the effect similar to that of the above-described broad-band FM demodulator, and the linearity of the broad-band FM demodulator can be improved. Moreover, since the differential circuit is used, integration is facilitated.

According to one aspect of the present invention, the respective circuits and constituting elements are integrated in the same chip in the broad-band FM demodulator.

According to the constitution, the broad-band FM demodulator according to one aspect of the present invention can obtain the effect similar to that of the above-described broad-band FM demodulator, and the linearity of the broad-band FM demodulator can be improved. With the constitution in the same chip, the characteristics are inhibited from deviating due to the mounting, and miniaturization is facilitated.

According to one aspect of the present invention, there is provided an optical receiving apparatus comprising:

the above-described broad-band FM demodulator;

light receiving element which converts a received optical signal to an electric signal; and

an amplifier which amplifies the signal outputted from the light receiving element and supplies the signal to the broad-band FM demodulator.

According to the constitution, since the linearity of the broad-band FM demodulator is improved, a high-quality multi-channel image signal having little distortion can be outputted with respect to the inputted optical signal.

According to one aspect of the present invention, there is provided an optical receiving apparatus wherein the amplifier and broad-band FM demodulator are integrated in the same chip.

According to the constitution, since the amplifier and broad-band FM demodulator are integrated in the same chip, a dispersion of characteristics because of the mounting is suppressed, and miniaturization is possible.

According to one aspect of the present invention, there is provided an optical transmission system comprising:

an optical transmission apparatus including an FM modulator which collectively converts a multi-channel image signal to an FM signal, an amplifier which amplifies the FM signal, and an LD which converts an output of the amplifier to an optical signal;

an optical amplifier which amplifies the optical signal outputted from the optical transmission apparatus;

a light split section which splits the amplified optical signal;

an optical fiber which transmits split optical signals; and

any one of the above-described optical receiving apparatus.

According to the constitution, the linearity of the broad-band FM demodulator mounted on the optical receiving apparatus is improved and thereby the high-quality multi-channel image signal having little distortion can be transmitted to a large number of optical receiving apparatus from one optical receiving apparatus. Moreover, even when nonlinearity is generated in the relation of the input voltage to the output frequency of the FM modulator mounted on the optical receiving apparatus, the fV characteristics of the broad-band FM demodulator incorporated in the optical receiving apparatus are adjusted so as to offset the nonlinearity of the FM modulator. Thereby, the high-quality multi-channel image signal having little distortion can be transmitted.

Additionally, embodiments of the present invention will be described hereinafter. To easily understand relations of many embodiments, drawings showing the embodiments, and related claims, refer to the following list.

TABLE 1

| Embodiment Number | Drawing | Claim |
|---|---|---|
| 1 | 1 | 1 |
| 2 | 7 | 6 |
| 3 | 8 | 7 |
| 4 | 9 | 2 |
| 5 | 10 | 8 |
| 6 | 11 | 9 |
| 7 | 12 | 3 |
| 8 | 13 | 6 |
| 9 | 14 | 7 |
| 10 | 15 | 4 |
| 11 | 16 | 6 |
| 12 | 17 | 10 |
| 13 | 18 | 7 |
| 14 | 19 | 11 |
| 15 | 20 | 5 |
| 16 | 21 | 8 |
| 17 | 22 | 10 |
| 18 | 23 | 7 |
| 19 | 24 | 12 |
| 20 | 25 | 23 |
| 21 | 26 | 23 |
| 22 | 27 | 1-5 |
| 23 | 28 | 24 |
| 24 | 29 | 27 |
| 25 | 30, 31 | 29 |
| 26 | 32 | 13 |
| 27 | 33 | 14 |
| 28 | 34 | 15 |
| 29 | 35 | 16 |
| 30 | 36 | 17 |
| 31 | 37 | 18 |
| 32 | 38 | 19 |
| 33 | 39 | 20 |
| 34 | 40 | 21 |
| 35 | 41 | 22 |

### BRIEF DESCRIPTION OF THE DRAWINGS

FIG. 1 is a block diagram of Embodiment 1 of an FM demodulator of the present invention;

FIG. 2 is a block diagram of a conventional FM demodulator;

FIGS. 3A to 3E are diagrams showing an operation principle of a delay detection type FM demodulator;

FIGS. 4A to 4F are diagrams showing deterioration of fV characteristics by deterioration of a waveform of the delay detection type FM demodulator;

FIGS. 5A to 5F are diagrams showing changes of the fV characteristics by a group delay;

FIGS. 6A to 6C are diagrams showing corrections of the fV characteristics by the group delay;

FIG. 7 is a block diagram of Embodiment 2 of the FM demodulator according to the present invention;

FIG. 8 is a block diagram of Embodiment 3 of the FM demodulator according to the present invention;

FIG. 9 is a block diagram of Embodiment 4 of the FM demodulator according to the present invention;

FIG. 10 is a block diagram of Embodiment 5 of the FM demodulator according to the present invention;

FIG. 11 is a block diagram of Embodiment 6 of the FM demodulator according to the present invention;

FIG. 12 is a block diagram of Embodiment 7 of the FM demodulator according to the present invention;

FIG. 13 is a block diagram of Embodiment 8 of the FM demodulator according to the present invention;

FIG. 14 is a block diagram of Embodiment 9 of the FM demodulator according to the present invention;

FIG. 15 is a block diagram of Embodiment 10 of the FM demodulator according to the present invention;

FIG. 16 is a block diagram of Embodiment 11 of the FM demodulator according to the present invention;

FIG. 17 is a block diagram of Embodiment 12 of the FM demodulator according to the present invention;

FIG. 18 is a block diagram of Embodiment 13 of the FM demodulator according to the present invention;

FIG. 19 is a block diagram of Embodiment 14 of the FM demodulator according to the present invention;

FIG. 20 is a block diagram of Embodiment 15 of the FM demodulator according to the present invention;

FIG. 21 is a block diagram of Embodiment 16 of the FM demodulator according to the present invention;

FIG. 22 is a block diagram of Embodiment 17 of the FM demodulator according to the present invention;

FIG. 23 is a block diagram of Embodiment 18 of the FM demodulator according to the present invention;

FIG. 24 is a block diagram of Embodiment 19 of the FM demodulator according to the present invention;

FIG. 25 is a block diagram of Embodiment 20 of the FM demodulator according to the present invention;

FIG. 26 is a block diagram of Embodiment 21 of the FM demodulator according to the present invention;

FIG. 27 is a block diagram of Embodiment 22 of the FM demodulator according to the present invention;

FIG. 28 is a block diagram of Embodiment 23 of the FM demodulator according to the present invention;

FIG. 29 is a block diagram of an optical receiving apparatus in Embodiment 24 of the FM demodulator according to the present invention;

FIG. 30 is a block diagram of an optical transmission apparatus for use in an optical transmission system as Embodiment 25 of the FM demodulator according to the present invention;

FIG. 31 is a block diagram of the optical transmission system as Embodiment 25 of the present invention;

FIG. 32 is a circuit diagram of a group delay frequency characteristics tilt delay circuit according to Embodiment 26 of the FM demodulator of the present invention;

FIG. 33 is a circuit diagram of the group delay frequency characteristics tilt delay circuit according to Embodiment 27 of the FM demodulator of the present invention;

FIG. 34 is a circuit diagram of the group delay frequency characteristics tilt delay circuit according to Embodiment 28 of the FM demodulator of the present invention;

FIG. 35 is a circuit diagram of the group delay frequency characteristics tilt delay circuit according to Embodiment 29 of the FM demodulator of the present invention;

FIG. 36 is a circuit diagram of a group delay frequency characteristics tilt amount variable delay circuit according to Embodiment 30 of the FM demodulator of the present invention;

FIG. 37 is a circuit diagram of the group delay frequency characteristics tilt amount variable delay circuit according to Embodiment 31 of the FM demodulator of the present invention;

FIG. 38 is a circuit diagram of a group delay frequency characteristics tilt amount adjustment circuit according to Embodiment 32 of the FM demodulator of the present invention;

FIG. 39 is a circuit diagram of the group delay frequency characteristics tilt amount adjustment circuit according to Embodiment 33 of the FM demodulator of the present invention;

FIG. 40 is a circuit diagram of a group delay frequency characteristics tilt circuit according to Embodiment 34 of the FM demodulator of the present invention; and

FIG. 41 is a circuit diagram of the group delay frequency characteristics tilt circuit according to Embodiment 35 of the FM demodulator of the present invention.

### DETAILED DESCRIPTION OF EMBODIMENTS OF THE INVENTION

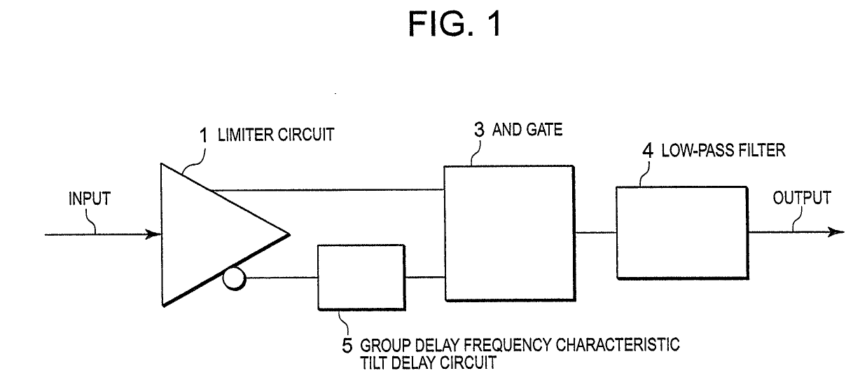

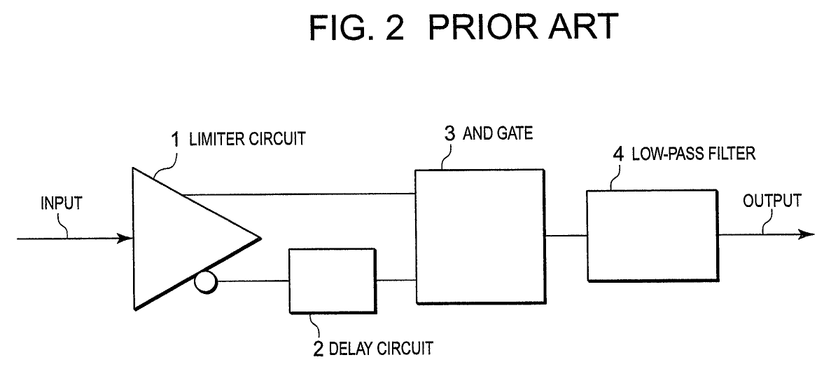

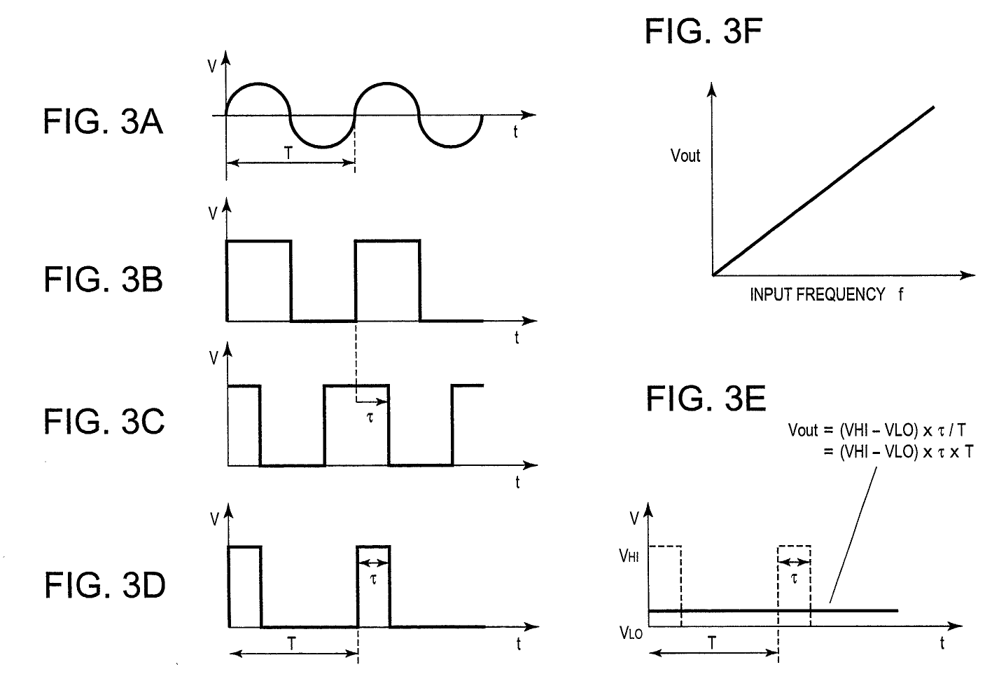

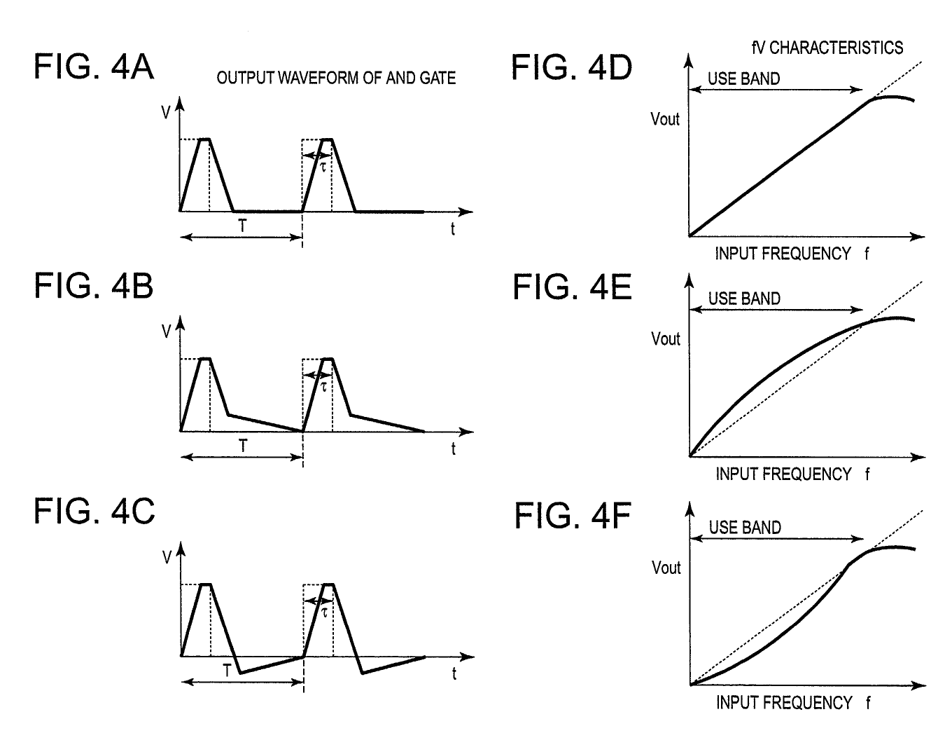

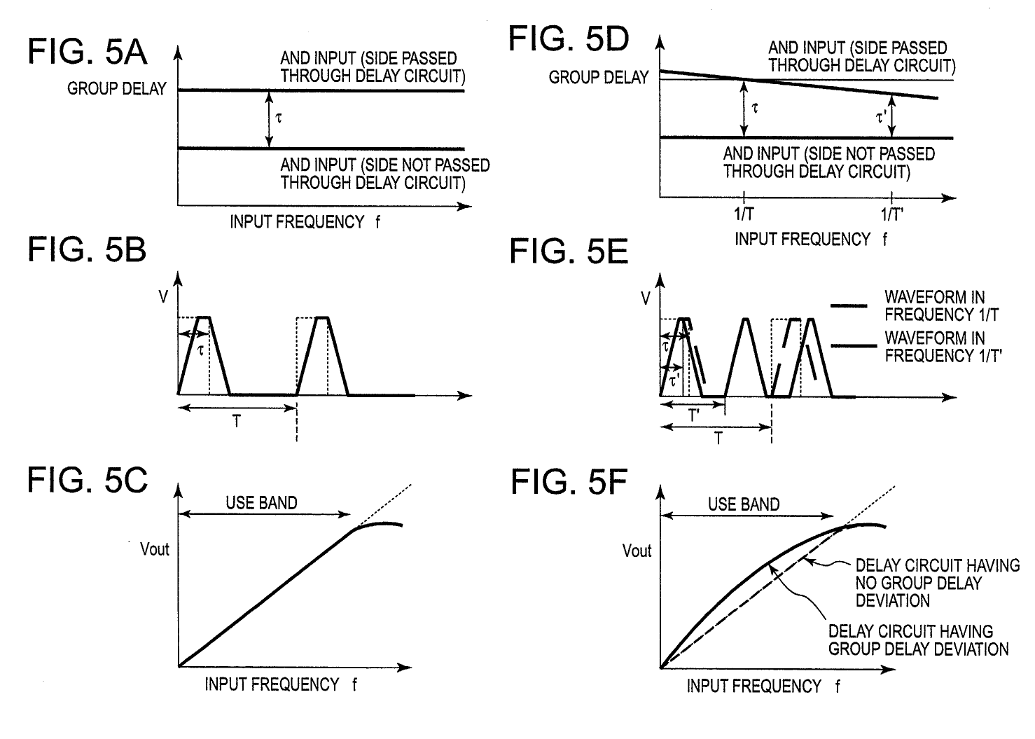

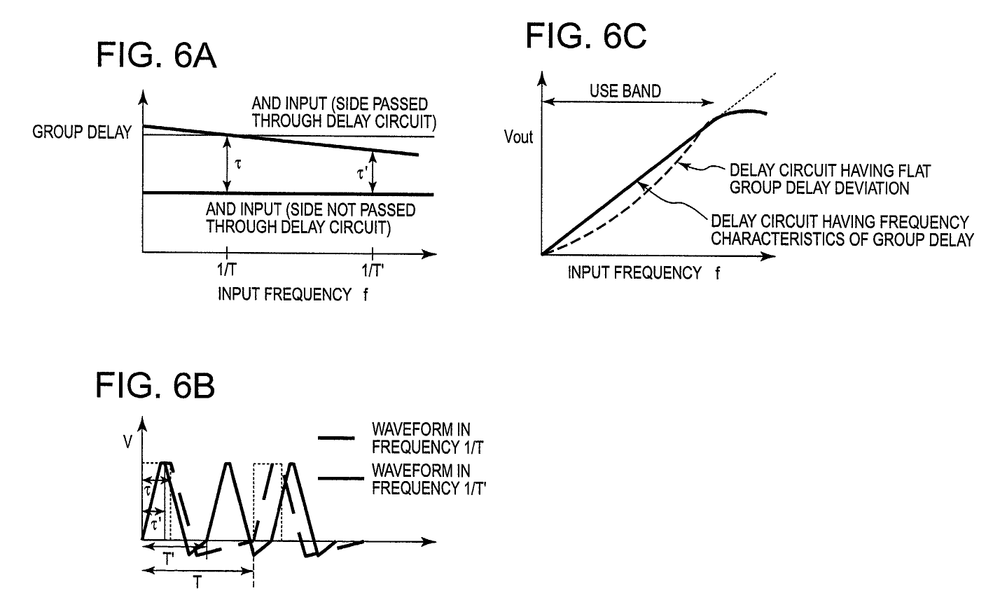

Embodiments of the present invention will be described hereinafter with reference to the drawings. FIG. 1 is a constitution diagram showing a first embodiment of a broad-band FM demodulator (hereinafter sometimes referred to simply as the FM demodulator) according to the present invention. The FM demodulator of the first embodiment includes: a limiter circuit 1 which converts an inputted FM signal to a pulse; a group delay frequency characteristics tilt delay circuit 5 as a delay circuit which has frequency characteristics in a group delay and which causes different delays in accordance with frequencies; an AND gate 3 which functions as multiplication means for outputting a logical product of the signal outputted by the limiter circuit 1 and the signal further delayed by the group delay frequency characteristics tilt delay circuit 5; and a low-pass filter 4 which obtains a demodulated signal from an output of the AND gate 3.

An operation of the first embodiment will next be described. The inputted FM signal is converted to a rectangular wave from a sine wave by the limiter circuit 1 and reverse and non-reverse signals are outputted. A non-reverse output from the limiter circuit 1 is inputted into the AND gate 3 as such, and the reverse output of the limiter circuit 1 is inputted into the group delay frequency characteristics tilt delay circuit 5. The group delay frequency characteristics tilt delay circuit 5 has frequency characteristics in the group delay and causes different delays in accordance with frequencies. Therefore, the reversed output of the limiter circuit 1 is passed through the group delay frequency characteristics tilt delay circuit 5, thereby has the delay which differs with the frequency, and is inputted into the AND gate 3. The AND gate 3 outputs a logical product of the output of the limiter circuit 1 and the signal of the group delay frequency characteristics tilt delay circuit 5, and thereby outputs a pulse having a pulse time width in accordance with a delay time difference of two signals inputted into the AND gate 3. The output of the AND gate 3 is passed through the low-pass filter 4 and a voltage is outputted in accordance with the frequency of the FM signal so that FM demodulation is performed.

Here, in the group delay frequency characteristics tilt delay circuit 5, a delay amount differs with the frequency and a pulse time width outputted from the AND gate 3 differs with the frequency. Therefore, when the pulse outputted from the AND gate 3 has a dragging or undershoot, nonlinearity is generated in fV characteristics. In this case, nonlinearity is imparted to the fV characteristics by group delay frequency characteristics by the group delay frequency characteristics tilt delay circuit 5, the fV characteristics are inversely corrected, and linearity is improved.

As described above, according to the first embodiment, when the pulse as the AND gate 3 output has the dragging or undershoot and thereby the nonlinearity is generated in the fV characteristics, the frequency characteristics are imparted to a delay difference of two signals inputted into the AND gate 3, and the linearity of the fV characteristics is improved. Thereby, a mutual modulation distortion generated in FM-demodulating a broad-band FM signal into a multi-channel AM image signal or digital image signal is suppressed, and transmission characteristics can be improved.

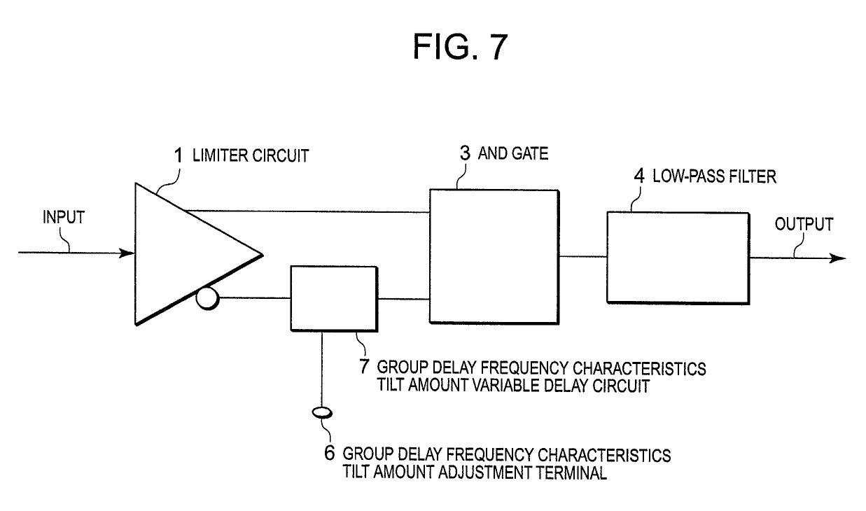

FIG. 7 is a constitution diagram showing a second embodiment of the FM demodulator according to the present invention. Here, respects different from the FM demodulator of the first embodiment will be described. In the FM demodulator of the second embodiment, the group delay frequency characteristics tilt delay circuit 5 in the FM demodulator of the first embodiment is changed to a group delay frequency characteristics tilt amount variable delay circuit 7. The circuit is a delay circuit which has frequency characteristics in the group delay, causes delays different with the frequency, and can change a tilt amount of a frequency characteristics curve of the group delay. The FM demodulator of the second embodiment further includes a group delay frequency characteristics tilt amount adjustment terminal 6 which gives a voltage for changing the tilt of the frequency characteristics curve of the group delay of the group delay frequency characteristics tilt amount variable delay circuit 7.

For an operation of the second embodiment, a part different from that of the first embodiment will next be described. The group delay frequency characteristics tilt amount variable delay circuit 7 is a delay circuit which has frequency characteristics in the group delay and causes the delay differing with the frequency. Furthermore, the tilt amount of the frequency characteristics curve of the delay is variable. Therefore, for example, when the FM demodulator is constituted as an IC, and when the nonlinearity of the fV characteristics by the dragging or undershoot of the FM demodulator varies, an optimum correction of the fV characteristics cannot be performed according to the constitution of the first embodiment. However, in the FM demodulator of the second embodiment, the group delay frequency characteristics tilt amount variable delay circuit 7 can change the tilt amount of the frequency characteristics curve of the group delay, and a precision for correcting the linearity of the fV characteristics can be enhanced.

As described above, according to the second embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 can be changed. Therefore, when the nonlinearity of the fV characteristics by the dragging or undershoot varies, an optimum correction can be achieved.

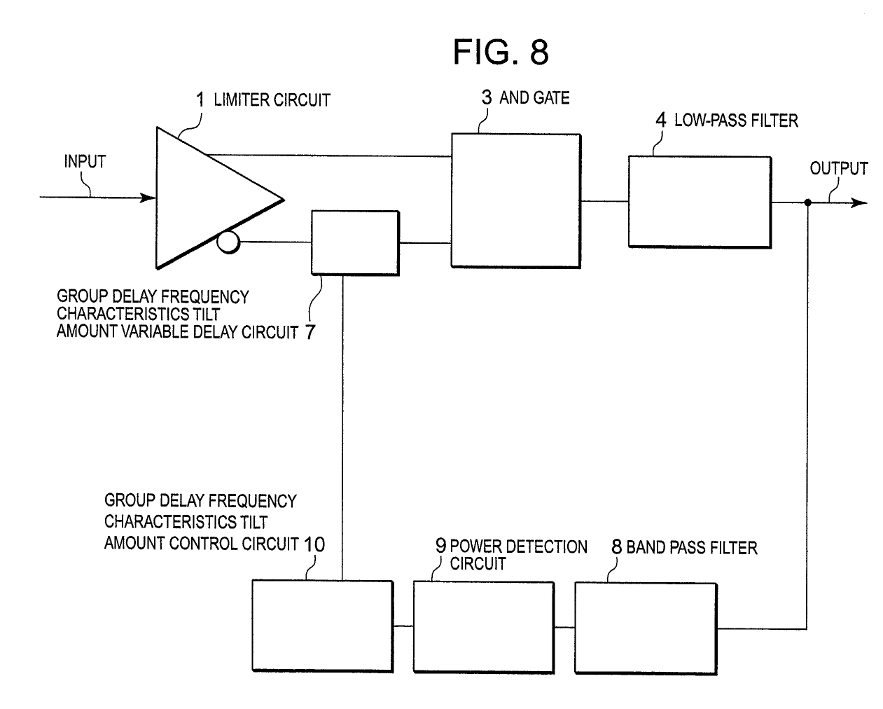

FIG. 8 is a constitution diagram showing a third embodiment of the FM demodulator according to the present invention. Here, respects different from those of the FM demodulator of the second embodiment will be described. In place of the group delay frequency characteristics tilt amount adjustment terminal 6, the FM demodulator of the third embodiment includes: a band pass filter 8 which extracts a distortion component of the signal outputted from the low-pass filter 4; a power detection circuit 9 which detects a level of the distortion component extracted by the band pass filter 8; and a group delay frequency characteristics tilt amount control circuit 10 which controls the group delay frequency characteristics tilt amount variable delay circuit 7 so as to minimize a distortion detection level.

For an operation of the third embodiment, a part different from that of the second embodiment will next be described. The distortion component of the signal outputted from the low-pass filter 4 is extracted by the band pass filter 8, and the power is detected by the power detection circuit 9. The group delay frequency characteristics tilt amount control circuit 10 controls the group delay frequency characteristics tilt amount variable delay circuit 7 so that the power of the distortion detected by the power detection circuit 9 is reduced. Thereby, the linearity of the FM demodulator can be improved.

As described above, according to the third embodiment, when the pulse as the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 are automatically changed, so that the distortion of the FM-demodulated signal is always minimized. Therefore, even when the nonlinearity of the fV characteristics because of the dragging or undershoot changes with an environment temperature, the optimum correction can be achieved.

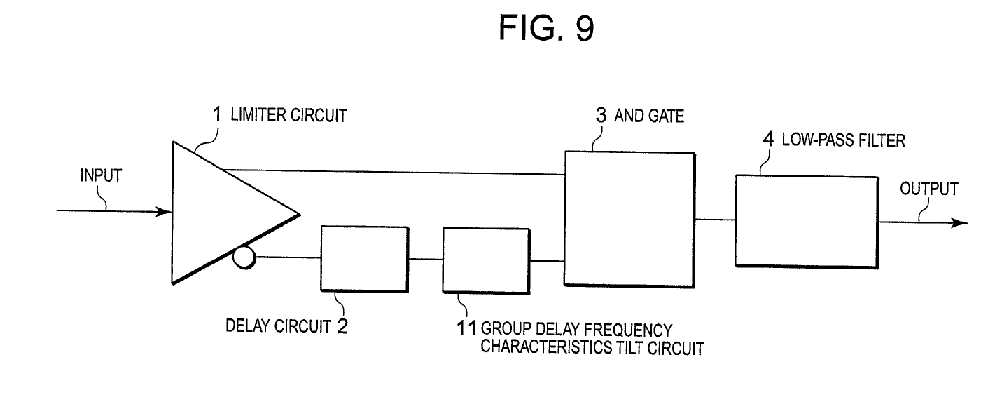

FIG. 9 is a constitution diagram showing a fourth embodiment of the FM demodulator according to the present invention. Here, the respects different from those of the FM demodulator of the first embodiment will be described. In the FM demodulator of the fourth embodiment, the group delay frequency characteristics tilt delay circuit 5 in the FM demodulator of the first embodiment is replaced with the delay circuit 2 in which the delay amount is constant regardless of the frequency. The FM demodulator further includes a group delay frequency characteristics tilt circuit 11 which is disposed between the delay circuit 2 and AND gate 3 and which can impart the frequency characteristics to the group delay of a delay circuit output passed through the tilt circuit. The group delay frequency characteristics tilt circuit 11 may be disposed between the limiter circuit and delay circuit 2.

An operation of the fourth embodiment will next be described. Here, a difference from the FM demodulator of the first embodiment will be described. For the outputs of the limiter circuit 1, the non-reversed output is inputted into the AND gate 3 as such, and the reversed output of the limiter circuit 1 is inputted into the delay circuit 2. The output of the delay circuit 2 having the delay which differs with the frequency is inputted into the AND gate 3 by the group delay frequency characteristics tilt circuit 11. The AND gate 3 outputs a logical product of the output of the limiter circuit 1 and the signal of the group delay frequency characteristics tilt circuit 11, and thereby outputs the pulse having the pulse time width in accordance with the delay time difference of two signals inputted into the AND gate 3. The output of the AND gate 3 is passed through the low-pass filter 4 and the voltage is outputted in accordance with the frequency of the FM signal so that FM demodulation is performed.

Here, the group delay frequency characteristics tilt circuit 11 converts the delay amount generated in the delay circuit 2 and having no frequency characteristics into the signal whose delay amount differs with the frequency in order to impart the frequency characteristics of the group delay to the inputted signal. Therefore, since the delay amounts of two signals inputted into the AND gate differ with the frequency, the pulse time width outputted from the AND gate 3 differs with the frequency. When the pulse of the AND gate 3 output has the dragging or undershoot, the nonlinearity is generated in the fV characteristics. In this case, the nonlinearity is imparted to the fV characteristics by the group delay frequency characteristics by the group delay frequency characteristics tilt circuit 11, the fV characteristics are thereby inversely corrected, and the linearity is improved.

As described above, according to the fourth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

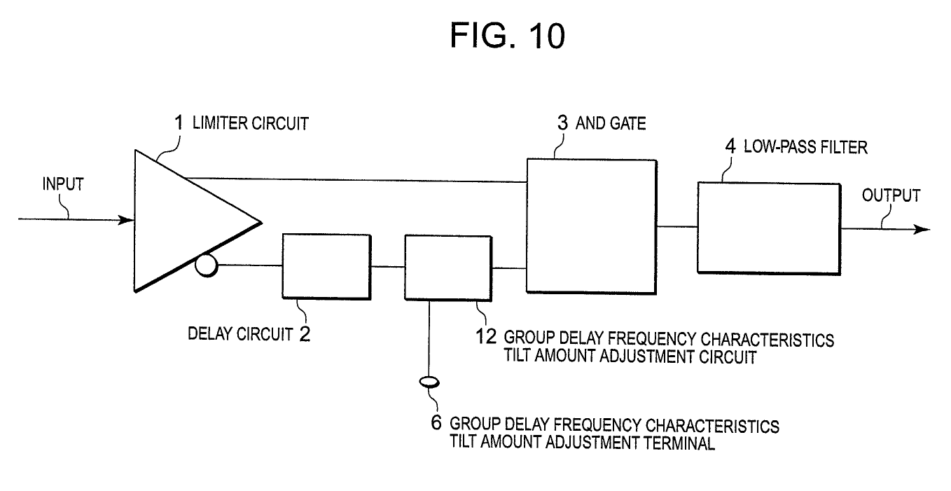

FIG. 10 is a constitution diagram showing a fifth embodiment of the FM demodulator according to the present invention. Here, the respects different from those of the FM demodulator of the fourth embodiment will be described. In the FM demodulator of the fifth embodiment, the group delay frequency characteristics tilt circuit 11 in the FM demodulator of the fourth embodiment is changed to a group delay frequency characteristics tilt amount adjustment circuit 12. This adjustment circuit is a delay circuit which can impart the frequency characteristics to the group delay of the delay circuit output passed through the adjustment circuit and can further change the tilt amount of the frequency characteristics curve of the group delay. Furthermore, the group delay frequency characteristics tilt amount adjustment terminal 6 is disposed to supply the voltage for changing the tilt of the frequency characteristics curve of the group delay of the group delay frequency characteristics tilt amount adjustment circuit 12.

For an operation of the fifth embodiment, the part different from that of the fourth embodiment will next be described. The group delay frequency characteristics tilt amount adjustment circuit 12 can impart the frequency characteristics to the group delay of the delay circuit output passed through the adjustment circuit, and further the tilt amount of the frequency characteristics curve of the delay is variable. For example, when the FM demodulator is constituted as the IC, and when the nonlinearity of the fV characteristics by the dragging or undershoot of the FM demodulator varies, the optimum correction of the fV characteristics cannot be performed according to the constitution of the fourth embodiment. However, in the FM demodulator of the fifth embodiment, the group delay frequency characteristics tilt amount adjustment circuit 12 can change the tilt amount of the frequency characteristics curve of the group delay, and the precision for correcting the linearity of the fV characteristics can be enhanced.

As described above, according to the fifth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 can be changed. Therefore, when the nonlinearity of the fV characteristics by the dragging or undershoot varies, the optimum correction can be achieved.

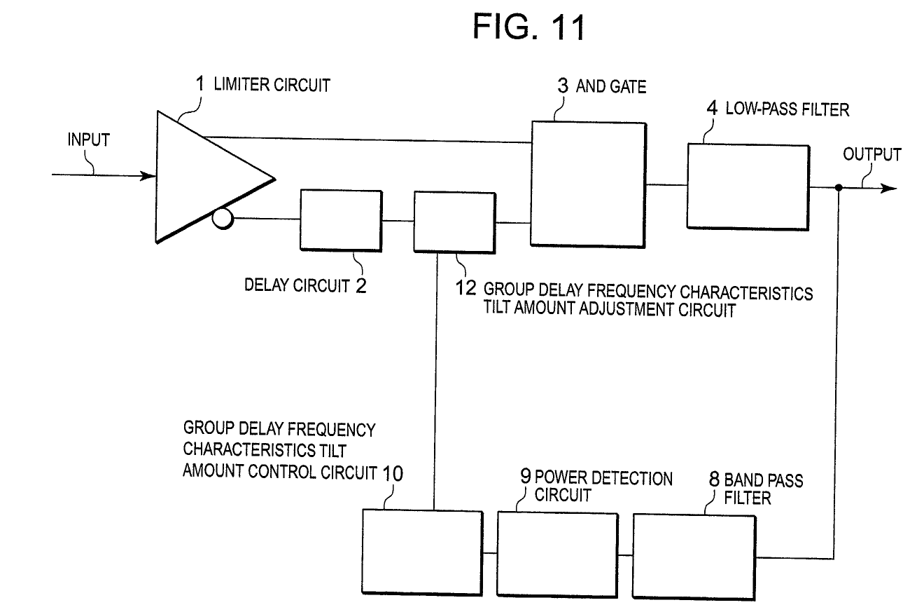

FIG. 11 is a constitution diagram showing a sixth embodiment of the FM demodulator according to the present invention. Here, the respects different from those of the FM demodulator of the fifth embodiment will be described. In place of the group delay frequency characteristics tilt amount adjustment terminal 6, the FM demodulator of the sixth embodiment includes: the band pass filter 8 which extracts the distortion component of the signal outputted from the low-pass filter 4; the power detection circuit 9 which detects the level of the distortion component extracted by the band pass filter 8; and the group delay frequency characteristics tilt amount control circuit 10 which controls the group delay frequency characteristics tilt amount adjustment circuit 12 so as to minimize the distortion detection level.

For an operation of the sixth embodiment, the part different from that of the fifth embodiment will next be described. The distortion component of the signal outputted from the low-pass filter 4 is extracted by the band pass filter 8, and the power is detected by the power detection circuit 9. The group delay frequency characteristics tilt amount control circuit 10 controls the group delay frequency characteristics tilt amount adjustment circuit 12 so that the power of the distortion detected by the power detection circuit 9 is reduced. Thereby, the linearity of the FM demodulator can be improved.

As described above, according to the sixth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 are automatically changed, so that the distortion of the FM-demodulated signal is always minimized. Therefore, even when the nonlinearity of the fV characteristics by the dragging or undershoot changes with the environment temperature, the optimum correction can be achieved.

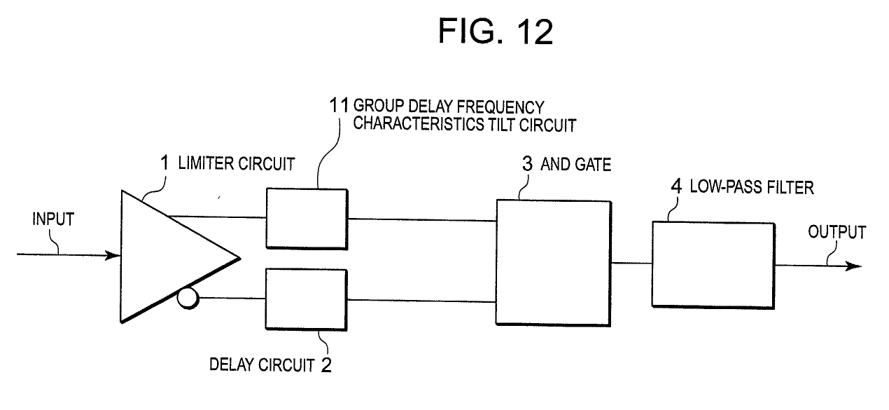

FIG. 12 is a constitution diagram showing a seventh embodiment of the FM demodulator according to the present invention. Here, the respects different from those of the FM demodulator of the fourth embodiment will be described. In the FM demodulator of the seventh embodiment, the FM demodulator is disposed between the limiter circuit 1 and AND gate 3 instead of disposing the group delay frequency characteristics tilt circuit 11 between the delay circuit 2 and AND gate 3 in the FM demodulator of the fourth embodiment.

An operation of the seventh embodiment will next be described. Here, a difference from the FM demodulator of the fourth embodiment will be described. For the outputs of the limiter circuit 1, the non-reversed output is inputted into the AND gate 3 with the delay which differs with the frequency by the group delay frequency characteristics tilt circuit 11. The reversed output of the limiter circuit 1 is inputted into the delay circuit 2. The output of the delay circuit 2 is inputted into the AND gate 3. The AND gate outputs a logical product of the signals of the group delay frequency characteristics tilt circuit 11 and delay circuit 2, and thereby outputs the pulse having the pulse time width in accordance with the delay time difference of two signals inputted into the AND gate 3. The output of the AND gate 3 is passed through the low-pass filter 4 and the voltage is outputted in accordance with the frequency of the FM signal so that FM demodulation is performed.

Here, the group delay frequency characteristics tilt circuit 11 converts the signal outputted from the limiter circuit 1 and having no frequency characteristics in the group delay into the signal whose group delay differs with the frequency in order to impart the frequency characteristics of the group delay to the inputted signal. Therefore, since the delay amounts of two signals inputted into the AND gate differ with the frequency, the pulse time width outputted from the AND gate 3 differs with the frequency. When the pulse of the AND gate 3 output has the dragging or undershoot, the nonlinearity is generated in the fV characteristics. In this case, the nonlinearity is imparted to the fV characteristics by the group delay frequency characteristics by the group delay frequency characteristics tilt circuit 11, the fV characteristics are thereby inversely corrected, and the linearity is improved.

As described above, according to the seventh embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved.

Thereby, the mutual modulation distortion generated in FM-demodulating the broad-band FM signal into the multi-channel AM image signal or digital image signal is suppressed, and the transmission characteristics can be improved.

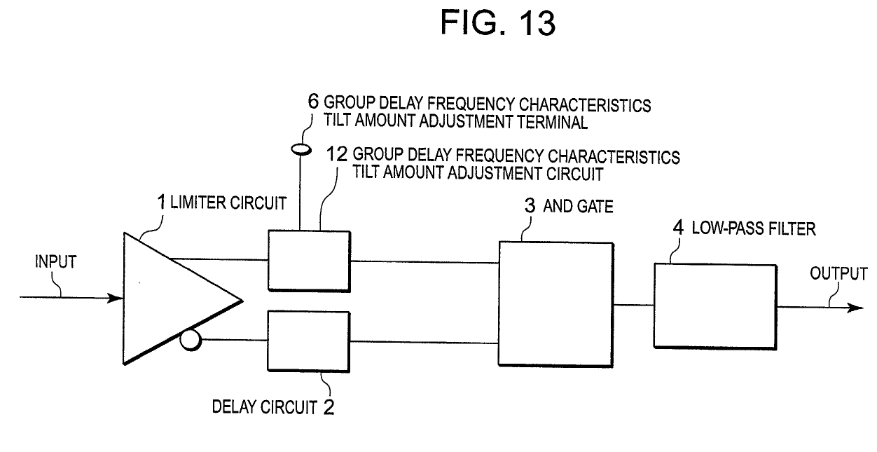

FIG. 13 is a constitution diagram showing an eighth embodiment of the FM demodulator according to the present invention. Here, the respects different from those of the FM demodulator of the seventh embodiment will be described. In the FM demodulator of the eighth embodiment, the group delay frequency characteristics tilt circuit 11 in the FM demodulator of the seventh embodiment is changed to the group delay frequency characteristics tilt amount adjustment circuit 12. This adjustment circuit is a delay circuit which can impart the frequency characteristics to the group delay of the delay circuit output passed through the adjustment circuit and can further change the tilt amount of the frequency characteristics curve of the group delay. Furthermore, the group delay frequency characteristics tilt amount adjustment terminal 6 is disposed to supply the voltage for changing the tilt of the frequency characteristics curve of the group delay of the group delay frequency characteristics tilt amount adjustment circuit 12.

For an operation of the eighth embodiment, the part different from that of the seventh embodiment will next be described. The group delay frequency characteristics tilt amount adjustment circuit 12 can impart the frequency characteristics to the group delay of the output of the limiter circuit 1 passed through the adjustment circuit, and further the tilt amount of the frequency characteristics curve of the delay is variable. For example, when the FM demodulator is constituted as the IC, and when the nonlinearity of the fV characteristics by the dragging or undershoot of the FM demodulator varies, the optimum correction of the fV characteristics cannot be performed according to the constitution of the seventh embodiment. However, in the FM demodulator of the eighth embodiment, the group delay frequency characteristics tilt amount adjustment circuit 12 can change the tilt amount of the frequency characteristics curve of the group delay, and the precision for correcting the linearity of the fV characteristics can be enhanced.

As described above, according to the eighth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

Furthermore, the frequency characteristics of the delay difference of two signals inputted into the AND gate 3 can be changed. Therefore, when the nonlinearity of the fV characteristics by the dragging or undershoot varies, the optimum correction can be achieved.

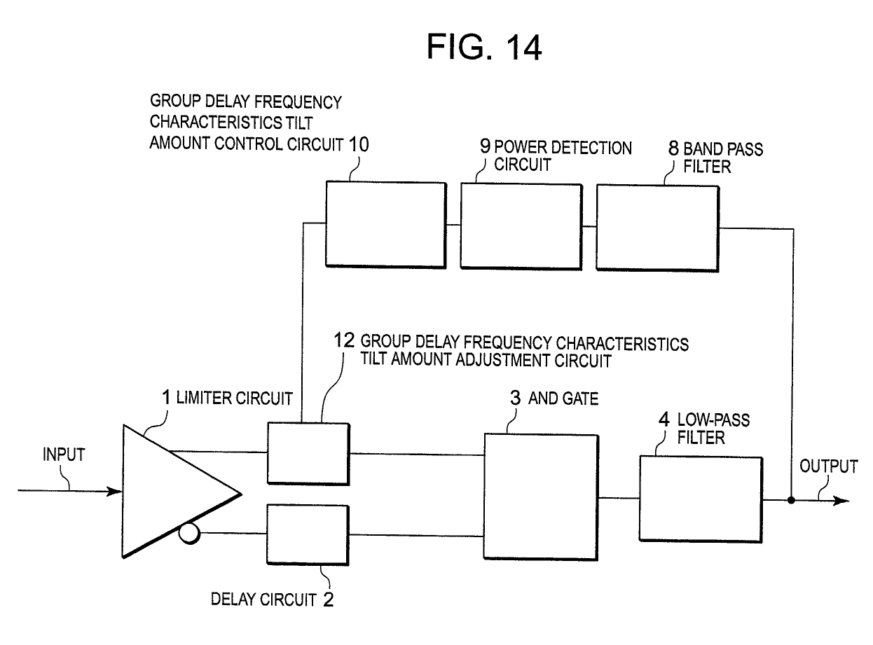

FIG. 14 is a constitution diagram showing a ninth embodiment of the FM demodulator according to the present invention. Here, the respects different from those of the FM demodulator of the eighth embodiment will be described. In place of the group delay frequency characteristics tilt amount adjustment terminal 6, the FM demodulator of the ninth embodiment includes: the band pass filter 8 which extracts the distortion component of the signal outputted from the low-pass filter 4; the power detection circuit 9 which detects the level of the distortion component extracted by the band pass filter 8; and the group delay frequency characteristics tilt amount control circuit 10 which controls the group delay frequency characteristics tilt amount adjustment circuit 12 so as to minimize the distortion detection level.

For an operation of the ninth embodiment, the part different from that of the eighth embodiment will next be described. The distortion component of the signal outputted from the low-pass filter 4 is extracted by the band pass filter 8, and the power is detected by the power detection circuit 9. The group delay frequency characteristics tilt amount control circuit 10 controls the group delay frequency characteristics tilt amount adjustment circuit 12 so that the power of the distortion detected by the power detection circuit 9 is reduced. Thereby, the linearity of the FM demodulator can be improved.

As described above, according to the ninth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 are automatically changed, so that the distortion of the FM-demodulated signal is always minimized. Therefore, even when the nonlinearity of the fV characteristics by the dragging or undershoot changes with the environment temperature, the optimum correction can be achieved.

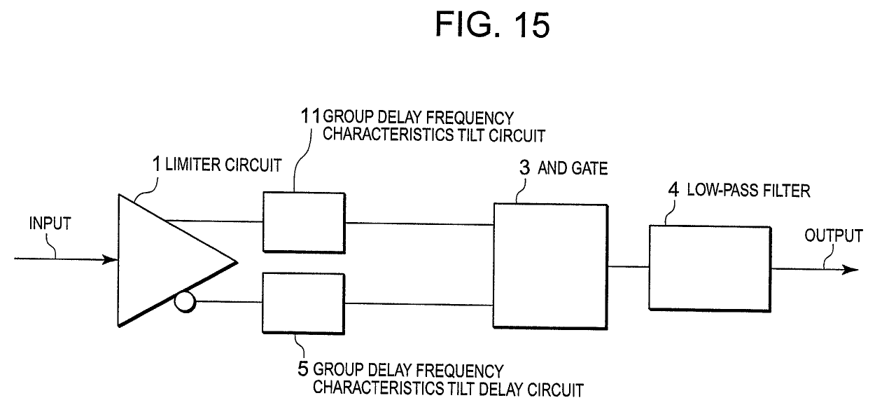

FIG. 15 is a constitution diagram showing a tenth embodiment of the FM demodulator according to the present invention. Here, the respects different from those of the FM demodulator of the seventh embodiment will be described. In the FM demodulator of the tenth embodiment, instead of the delay circuit 2 in the FM demodulator of the seventh embodiment, the group delay frequency characteristics tilt delay circuit 5 is disposed which has the frequency characteristics in the group delay and causes the delay differing with the frequency.

An operation of the tenth embodiment will next be described. Here, a difference from the FM demodulator of the seventh embodiment will be described. For the outputs of the limiter circuit 1, the non-reversed output is inputted into the AND gate 3 with the delay which differs with the frequency by the group delay frequency characteristics tilt circuit 11. On the other hand, the reversed output of the limiter circuit 1 is inputted into the group delay frequency characteristics tilt delay circuit 5. The group delay frequency characteristics tilt delay circuit 5 has the frequency characteristics in the group delay and causes the delay which differs with the frequency. Therefore, the reversed output of the limiter circuit 1 is passed through the group delay frequency characteristics tilt delay circuit 5 and is inputted into the AND gate 3 with the delay which differs with the frequency. Here, both the delay amounts of two signals inputted into the AND gate 3 differ with the frequency, and the pulse having the pulse time width is outputted in accordance with the difference of the delay amount. The output of the AND gate 3 is passed through the low-pass filter 4 and the voltage is outputted in accordance with the frequency of the FM signal so that FM demodulation is performed.

Here, both the group delay frequency characteristics tilt circuit 11 and the group delay frequency characteristics tilt delay circuit 5 have the frequency characteristics in the group delay. Since the delay amounts of two signals inputted into the AND gate differ with the frequency, the pulse time width outputted from the AND gate 3 differs with the frequency. When the pulse of the AND gate 3 output has the dragging or undershoot, the nonlinearity is generated in the fV characteristics. In this case, the nonlinearity is imparted to the fV characteristics by the difference of the frequency characteristics of the group delays of the group delay frequency characteristics tilt circuit 11 and group delay frequency characteristics tilt delay circuit 5, the fV characteristics are thereby inversely corrected, and the linearity is improved.

As described above, according to the tenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

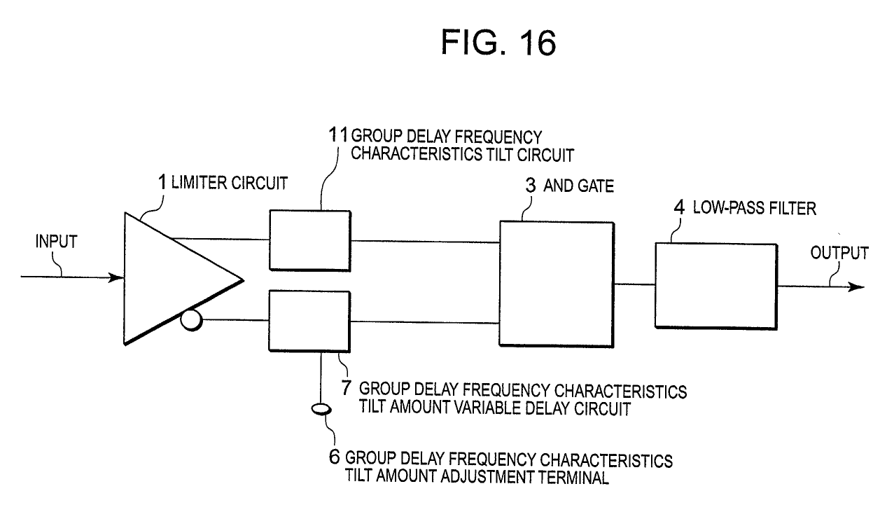

FIG. 16 is a constitution diagram showing an eleventh embodiment of the FM demodulator according to the present invention. Here, the respects different from those of the FM demodulator of the tenth embodiment will be described. In the FM demodulator of the eleventh embodiment, the group delay frequency characteristics tilt delay circuit 5 in the FM demodulator of the tenth embodiment is changed to the group delay frequency characteristics tilt amount variable delay circuit 7. This delay circuit is a delay circuit which has the frequency characteristics in the group delay, causes the delay which differs with the frequency, and can further change the tilt amount of the frequency characteristics curve of the group delay. Furthermore, the group delay frequency characteristics tilt amount adjustment terminal 6 is disposed to supply the voltage for changing the tilt of the frequency characteristics curve of the group delay of the group delay frequency characteristics tilt amount variable delay circuit 7.

For an operation of the eleventh embodiment, the part different from that of the tenth embodiment will next be described. The group delay frequency characteristics tilt amount variable delay circuit 7 is the delay circuit which has the frequency characteristics in the group delay and causes the delay different with the frequency, and further the tilt amount of the frequency characteristics curve of the delay is variable. For example, when the FM demodulator is constituted as the IC, and when the nonlinearity of the fV characteristics by the dragging or undershoot of the FM demodulator varies, the optimum correction of the fV characteristics cannot be performed according to the constitution of the tenth embodiment. However, in the FM demodulator of the eleventh embodiment, the group delay frequency characteristics tilt amount variable delay circuit 7 can change the tilt amount of the frequency characteristics curve of the group delay, and the frequency characteristics are balanced with the frequency characteristics of the group delay of the group delay frequency characteristics tilt circuit 11. Thereby, the precision for correcting the linearity of the fV characteristics can be enhanced.

As described above, according to the eleventh embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 can be changed. Therefore, when the nonlinearity of the fV characteristics by the dragging or undershoot varies, the optimum correction can be achieved.

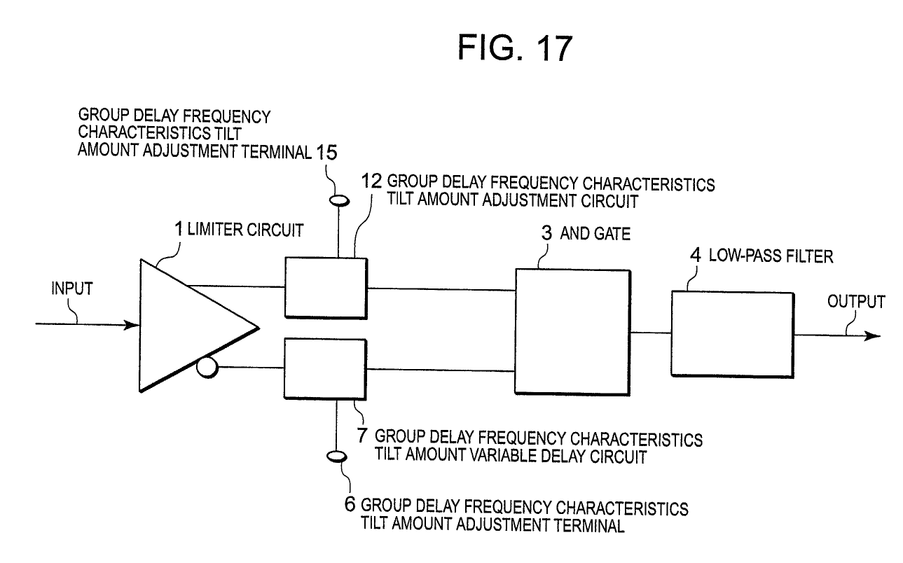

FIG. 17 is a constitution diagram showing a twelfth embodiment of the FM demodulator according to the present invention. Here, the respects different from those of the FM demodulator of the eleventh embodiment will be described. In the delay circuit 2 of the twelfth embodiment, the group delay frequency characteristics tilt circuit 11 in the FM demodulator of the eleventh embodiment is changed to the group delay frequency characteristics tilt amount adjustment circuit 12. This adjustment circuit can impart the frequency characteristics to the group delay of the delay circuit output passed through the adjustment circuit and can further change the tilt amount of the frequency characteristics curve of the group delay. Furthermore, a group delay frequency characteristics tilt amount adjustment terminal 15 is disposed to supply the voltage for changing the tilt of the frequency characteristics curve of the group delay of the group delay frequency characteristics tilt amount adjustment circuit 12.

For an operation of the twelfth embodiment, the part different from that of the eleventh embodiment will next be described. In the FM demodulator of the twelfth embodiment, the group delay frequency characteristics tilt circuit 11 of the eleventh embodiment is changed to the group delay frequency characteristics tilt amount adjustment circuit 12 which can impart the frequency characteristics to the group delay of the delay circuit output passed through the adjustment circuit and can further change the tilt amount of the frequency characteristics curve of the group delay. Therefore, the linearity of the fV characteristics can be corrected by the difference of the group delay frequency characteristics of the group delay frequency characteristics tilt amount variable delay circuit 7 and group delay frequency characteristics tilt amount adjustment circuit 12. Furthermore, both the group delay frequency characteristics of the group delay frequency characteristics tilt amount variable delay circuit 7 and group delay frequency characteristics tilt amount adjustment circuit 12 can be adjusted, and therefore the precision of the correction of the fV characteristics of the FM demodulator can be enhanced.

As described above, according to the twelfth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 can be changed. Therefore, when the nonlinearity of the fV characteristics by the dragging or undershoot varies, the optimum correction can be achieved.

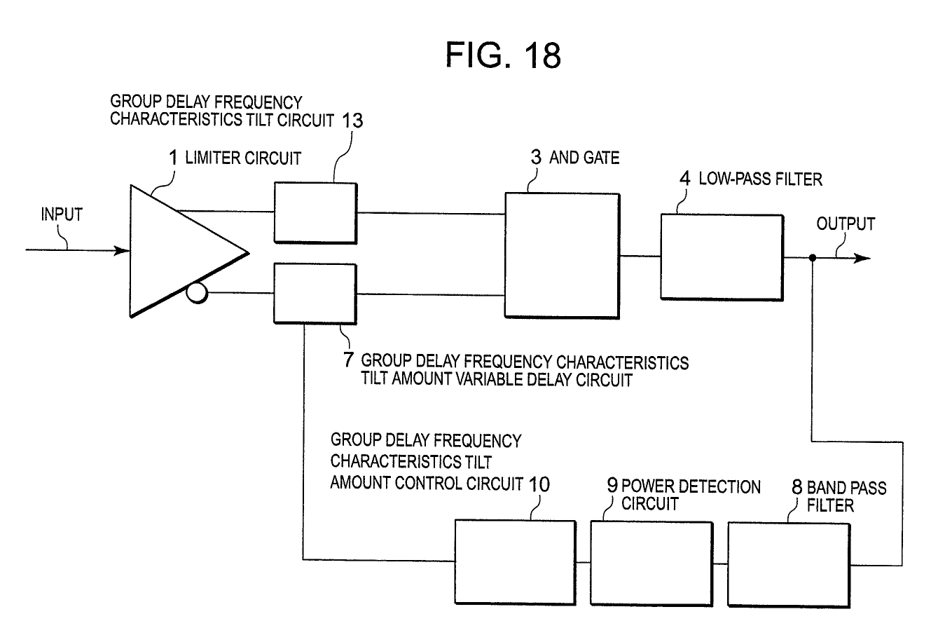

FIG. 18 is a constitution diagram showing a thirteenth embodiment of the FM demodulator according to the present invention. Here, the respects different from those of the FM demodulator of the eleventh embodiment will be described. In place of the group delay frequency characteristics tilt amount adjustment terminal 6, the FM demodulator of the thirteenth embodiment includes: the band pass filter 8 which extracts the distortion component of the signal outputted from the low-pass filter 4; the power detection circuit 9 which detects the level of the distortion component extracted by the band pass filter 8; and the group delay frequency characteristics tilt amount control circuit 10 which controls the group delay frequency characteristics tilt amount variable delay circuit 7 so as to minimize the distortion detection level.

For an operation of the thirteenth embodiment, the part different from that of the eleventh embodiment will next be described. The distortion component of the signal outputted from the low-pass filter 4 is extracted by the band pass filter 8, and the power is detected by the power detection circuit 9. The group delay frequency characteristics tilt amount control circuit 10 controls the group delay frequency characteristics tilt amount variable delay circuit 7 so that the power of the distortion detected by the power detection circuit 9 is reduced. Thereby, the linearity of the FM demodulator can be improved.

As described above, according to the thirteenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 are automatically changed, so that the distortion of the FM-demodulated signal is always minimized. Therefore, even when the nonlinearity of the fV characteristics by the dragging or undershoot changes with the environment temperature, the optimum correction can be achieved.

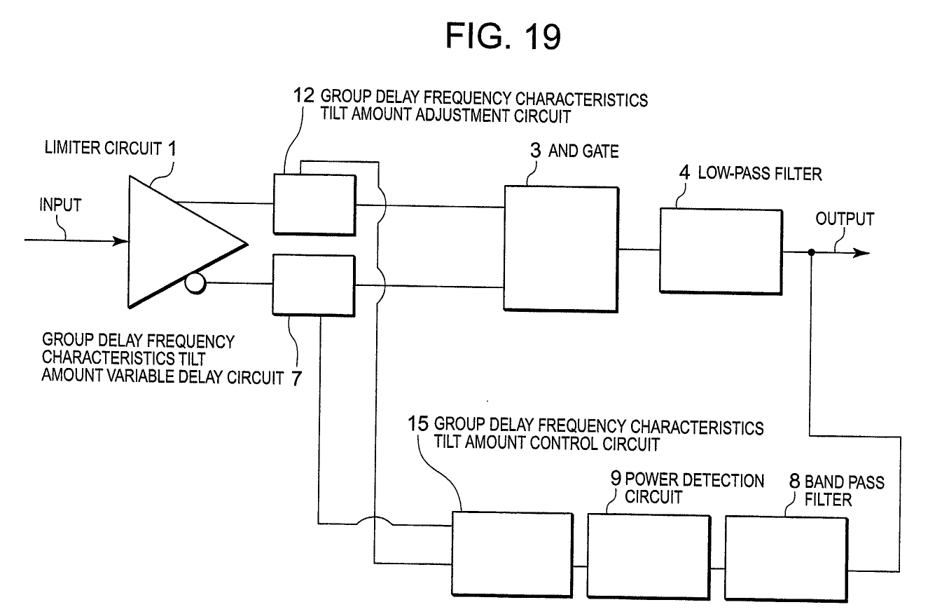

FIG. 19 is a constitution diagram showing a fourteenth embodiment of the FM demodulator according to the present invention. Here, the respects different from those of the FM demodulator of the thirteenth embodiment will be described. In the FM demodulator of the fourteenth embodiment, the constitution and function of the group delay frequency characteristics tilt amount control circuit 10 are changed. The FM demodulator includes: the band pass filter 8 which extracts the distortion component of the signal outputted from the low-pass filter 4; the power detection circuit 9 which detects the level of the distortion component extracted by the band pass filter 8; and a group delay frequency characteristics tilt amount control circuit 15 which controls the group delay frequency characteristics tilt amount variable delay circuit 7 and group delay frequency characteristics tilt amount adjustment circuit 12 so as to minimize the distortion detection level.

For an operation of the fourteenth embodiment, the part different from that of the thirteenth embodiment will next be described. The distortion component of the signal outputted from the low-pass filter 4 is extracted by the band pass filter 8, and the power is detected by the power detection circuit 9. The group delay frequency characteristics tilt amount control circuit 15 controls the group delay frequency characteristics tilt amount variable delay circuit 7 and group delay frequency characteristics tilt amount adjustment circuit 12 so that the power of the distortion detected by the power detection circuit 9 is reduced. Thereby, the linearity of the FM demodulator can be improved.

As described above, according to the fourteenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 are automatically changed, so that the distortion of the FM-demodulated signal is always minimized. Therefore, even when the nonlinearity of the fV characteristics by the dragging or undershoot changes with the environment temperature, the optimum correction can be achieved.

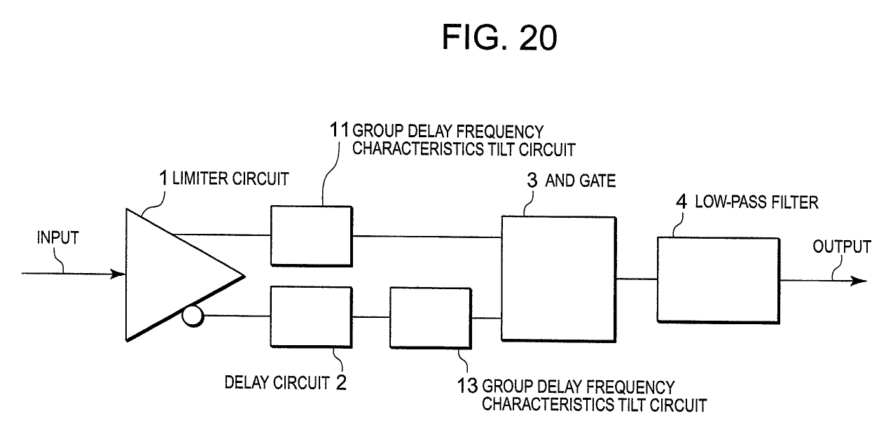

FIG. 20 is a constitution diagram showing a fifteenth embodiment of the FM demodulator according to the present invention. Here, the respects different from those of the FM demodulator of the seventh embodiment will be described. In the FM demodulator of the fifteenth embodiment, a group delay frequency characteristics tilt circuit 13 is added between the delay circuit 2 and AND gate 3 in the FM demodulator of the seventh embodiment. The tilt circuit can impart the frequency characteristics to the group delay of the delay circuit output passed through the tilt circuit, and can further change the tilt amount of the frequency characteristics curve of the group delay.

An operation of the fifteenth embodiment will next be described. Here, a difference from the FM demodulator of the seventh embodiment will be described. For the outputs of the limiter circuit 1, the non-reversed output is inputted into the AND gate 3 with the delay which differs with the frequency by the group delay frequency characteristics tilt circuit 11. On the other hand, the reversed output of the limiter circuit 1 is inputted into the group delay frequency characteristics tilt circuit 13 via the delay circuit 2. The output passed through the group delay frequency characteristics tilt circuit 13 has the frequency characteristics in the group delay and the circuit causes the delay which differs with the frequency. Therefore, the reversed output of the limiter circuit 1 is passed through the group delay frequency characteristics tilt circuit 13 and is inputted into the AND gate 3 with the delay which differs with the frequency. Here, both the delay amounts of two signals inputted into the AND gate 3 differ with the frequency, and the pulse having the pulse time width is outputted in accordance with the difference of the delay amount. The output of the AND gate 3 is passed through the low-pass filter 4 and the voltage is outputted in accordance with the frequency of the FM signal so that FM demodulation is performed.

Here, both the group delay frequency characteristics tilt circuit 11 and the group delay frequency characteristics tilt circuit 13 have the frequency characteristics in the group delay. Since the delay amounts of two signals inputted into the AND gate differ with the frequency, the pulse time width outputted from the AND gate 3 differs with the frequency. When the pulse of the AND gate 3 output has the dragging or undershoot, the nonlinearity is generated in the fV characteristics. In this case, the nonlinearity is imparted to the fV characteristics by the difference of the frequency characteristics of the group delays of the group delay frequency characteristics tilt circuits 11 and 13, the fV characteristics are thereby inversely corrected, and the linearity is improved.

As described above, according to the fifteenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

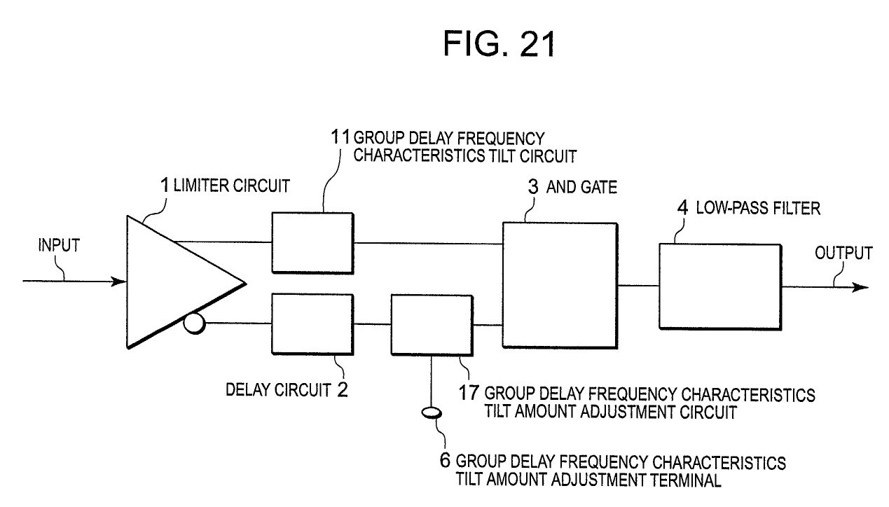

FIG. 21 is a constitution diagram showing a sixteenth embodiment of the FM demodulator according to the present invention. Here, the respects different from those of the FM demodulator of the fifteenth embodiment will be described. In the FM demodulator of the sixteenth embodiment, the group delay frequency characteristics tilt circuit 13 of the fifteenth embodiment is changed to a group delay frequency characteristics tilt amount adjustment circuit 17 which passes the delay circuit output, can thereby impart the frequency characteristics to the group delay of the delay circuit output, and can further change the tilt amount of the frequency characteristics curve of the group delay. Furthermore, the group delay frequency characteristics tilt amount adjustment terminal 6 is disposed to supply the voltage for changing the tilt of the slope of the frequency characteristics curve of the group delay of the group delay frequency characteristics tilt amount adjustment circuit 17.

For an operation of the sixteenth embodiment, the part different from that of the fifteenth embodiment will next be described. In the FM demodulator of the sixteenth embodiment, the group delay frequency characteristics tilt circuit 13 is changed to the group delay frequency characteristics tilt amount adjustment circuit 17 as the delay circuit which passes the delay circuit output, can thereby impart the frequency characteristics to the group delay of the output, and can further change the tilt amount of the frequency characteristics curve of the group delay. Therefore, the linearity of the fV characteristics can be corrected by the difference of the group delay frequency characteristics of the group delay frequency characteristics tilt circuit 11 and group delay frequency characteristics tilt amount adjustment circuit 17. Furthermore, since the group delay frequency characteristics of the group delay frequency characteristics tilt amount adjustment circuit 17 can be adjusted, the precision of the correction of the fV characteristics of the FM demodulator can be enhanced.

As described above, according to the sixteenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 can be changed. Therefore, when the nonlinearity of the fV characteristics by the dragging or undershoot varies, the optimum correction can be achieved.

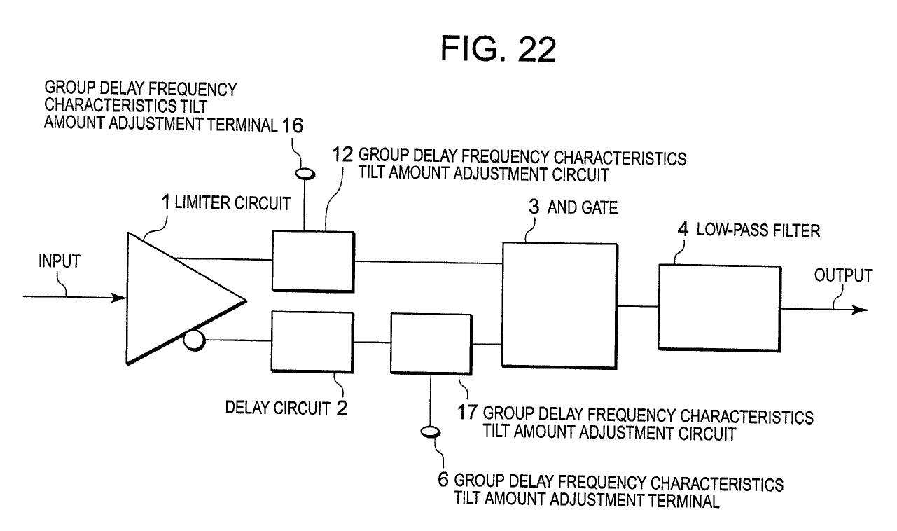

FIG. 22 is a constitution diagram showing a seventeenth embodiment of the FM demodulator according to the present invention. Here, the respects different from those of the FM demodulator of the sixteenth embodiment will be described. In the FM demodulator of the seventeenth embodiment, the group delay frequency characteristics tilt circuit 11 is changed to the group delay frequency characteristics tilt amount adjustment circuit 12 as the delay circuit which passes the delay circuit output, can thereby impart the frequency characteristics to the group delay of the output, and can further change the tilt amount of the frequency characteristics curve of the group delay. Furthermore, a group delay frequency characteristics tilt amount adjustment terminal 16 is disposed to supply the voltage for changing the tilt of the slope of the frequency characteristics curve of the group delay of the group delay frequency characteristics tilt amount adjustment circuit 12.

For an operation of the seventeenth embodiment, the part different from that of the sixteenth embodiment will next be described. In the FM demodulator of the seventeenth embodiment, the group delay frequency characteristics tilt circuit 11 of the sixteenth embodiment is changed to the group delay frequency characteristics tilt amount adjustment circuit 12 as the delay circuit which passes the delay circuit output, can thereby impart the frequency characteristics to the group delay of the output, and can further change the tilt amount of the frequency characteristics curve of the group delay. Therefore, the linearity of the fV characteristics can be corrected by the difference of the group delay frequency characteristics of the group delay frequency characteristics tilt amount adjustment circuits 17 and 12. Furthermore, since the group delay frequency characteristics of the group delay frequency characteristics tilt amount adjustment circuits 12 and 17 can be adjusted, the precision of the correction of the fV characteristics of the FM demodulator can be enhanced.

As described above, according to the seventeenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 can be changed. Therefore, when the nonlinearity of the fV characteristics by the dragging or undershoot varies, the optimum correction can be achieved.

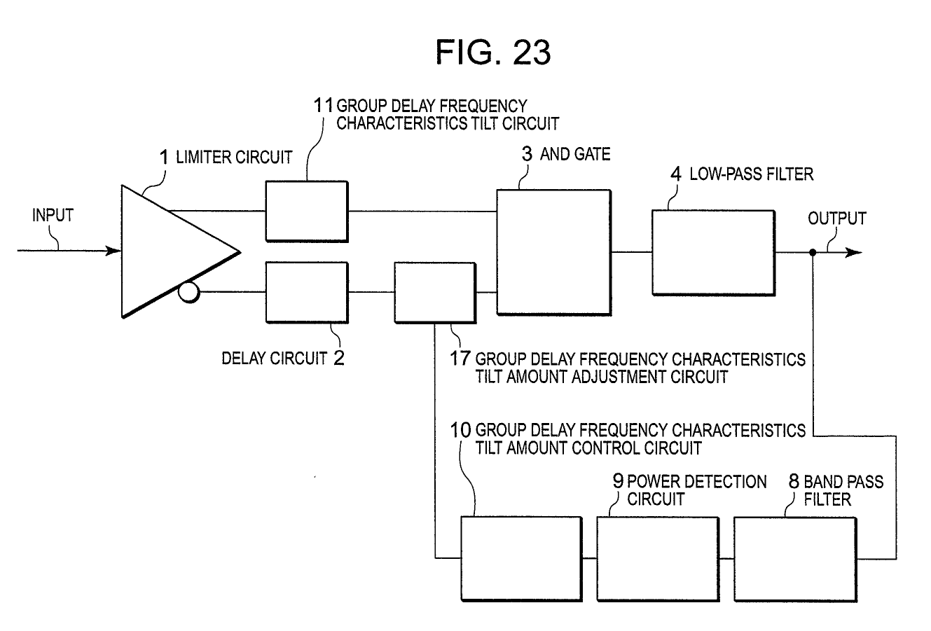

FIG. 23 is a constitution diagram showing an eighteenth embodiment of the FM demodulator according to the present invention. Here, the respects different from those of the FM demodulator of the sixteenth embodiment will be described. In the FM demodulator of the eighteenth embodiment, the group delay frequency characteristics tilt amount adjustment terminal 6 is replaced. The FM demodulator includes: the band pass filter 8 which extracts the distortion component of the signal outputted from the low-pass filter 4; the power detection circuit 9 which detects the level of the distortion component extracted by the band pass filter 8; and the group delay frequency characteristics tilt amount control circuit 10 which controls the group delay frequency characteristics tilt amount adjustment circuit 17 so as to minimize the distortion detection level.

For an operation of the eighteenth embodiment, the part different from that of the sixteenth embodiment will next be described. The distortion component of the signal outputted from the low-pass filter 4 is extracted by the band pass filter 8, and the power is detected by the power detection circuit 9. The group delay frequency characteristics tilt amount control circuit 10 controls the group delay frequency characteristics tilt amount adjustment circuit 17 so that the power of the distortion detected by the power detection circuit 9 is reduced. Thereby, the linearity of the FM demodulator can be improved.

As described above, according to the eighteenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 are automatically changed, so that the distortion of the FM-demodulated signal is always minimized. Therefore, even when the nonlinearity of the fV characteristics by the dragging or undershoot changes with the environment temperature, the optimum correction can be achieved.

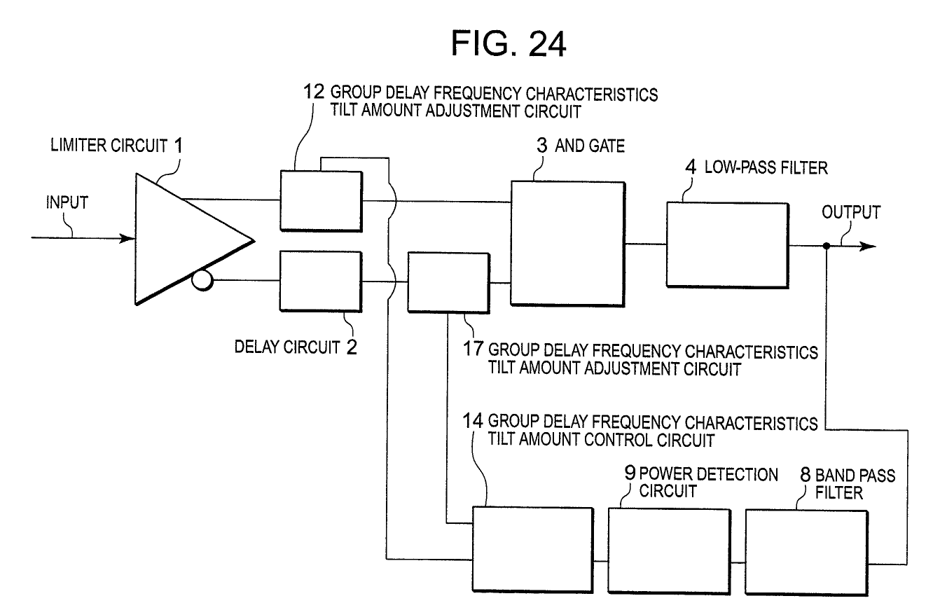

FIG. 24 is a constitution diagram showing a nineteenth embodiment of the FM demodulator according to the present invention. Here, the respects different from those of the FM demodulator of the seventeenth embodiment will be described. In the FM demodulator of the nineteenth embodiment, the group delay frequency characteristics tilt amount adjustment terminals 6 and 16 are replaced. Instead, the FM demodulator includes: the band pass filter 8 which extracts the distortion component of the signal outputted from the low-pass filter 4; the power detection circuit 9 which detects the level of the distortion component extracted by the band pass filter 8; and a group delay frequency characteristics tilt amount control circuit 14 which controls the group delay frequency characteristics tilt amount adjustment circuits 17 and 12 so as to minimize the distortion detection level.

For an operation of the nineteenth embodiment, the part different from that of the seventeenth embodiment will next be described. The distortion component of the signal outputted from the low-pass filter 4 is extracted by the band pass filter 8, and the power is detected by the power detection circuit 9. The group delay frequency characteristics tilt amount control circuit 14 controls the group delay frequency characteristics tilt amount adjustment circuits 17 and 12 so that the power of the distortion detected by the power detection circuit 9 is reduced. Thereby, the linearity of the FM demodulator can be improved.

As described above, according to the nineteenth embodiment, when the pulse of the AND gate 3 output has the dragging or undershoot and thereby the nonlinearity is generated in the fV characteristics, the frequency characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved. Furthermore, the frequency characteristics of the delay difference of two signals inputted into the AND gate 3 are automatically changed, so that the distortion of the FM-demodulated signal is always minimized. Therefore, even when the nonlinearity of the fV characteristics by the dragging or undershoot changes with the environment temperature, the optimum correction can be achieved.

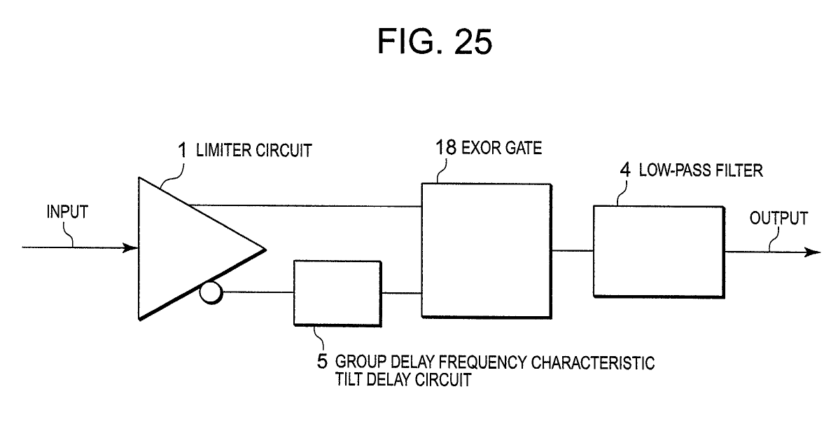

FIG. 25 is a constitution diagram showing a twentieth embodiment of the FM demodulator according to the present invention. Here, the respects different from those of the FM demodulator of the first embodiment will be described. In the FM demodulator of the twentieth embodiment, the AND gate 3 which outputs a logical product of the signal outputted from the limiter circuit 1 and the signal delayed by the group delay frequency characteristics tilt delay circuit 5 is replaced with an EXOR gate 18.

An operation of the twentieth embodiment will next be described. The inputted FM signal is converted to the rectangular wave from the sine wave by the limiter circuit 1 and the reverse and non-reverse signals are outputted. For the outputs of the limiter circuit 1, a non-reversed output is inputted into the EXOR gate 18 as such, and the reversed output of the limiter circuit 1 is inputted into the group delay frequency characteristics tilt delay circuit 5. The group delay frequency characteristics tilt delay circuit 5 has frequency characteristics in the group delay and causes the delay which differs with the frequency. Therefore, the reversed output of the limiter circuit 1 is passed through the group delay frequency characteristics tilt delay circuit 5, thereby has the delay which differs with the frequency, and is inputted into the EXOR gate 18. Similarly as the AND gate 3 of the first embodiment, the EXOR gate 18 outputs a logical product of the output of the limiter circuit 1 and the signal of the group delay frequency characteristics tilt delay circuit 5, and thereby outputs a pulse having the pulse time width in accordance with the delay time difference of two signals inputted into the EXOR gate 18. The output of the EXOR gate 18 is passed through the low-pass filter 4 and the voltage is outputted in accordance with the frequency of the FM signal so that FM demodulation is performed.

Here, in the group delay frequency characteristics tilt delay circuit 5, the delay amount differs with the frequency and the pulse time width outputted from the EXOR gate 18 differs with the frequency. Therefore, when the pulse of the EXOR gate 18 output has the dragging or undershoot, the nonlinearity is generated in the fV characteristics. In this case, the nonlinearity is imparted to the fV characteristics by the group delay frequency characteristics by the group delay frequency characteristics tilt delay circuit 5, the fV characteristics are inversely corrected, and the linearity is improved.

As described above, according to the twentieth embodiment, when the pulse of the EXOR gate 18 output has the dragging or undershoot and thereby the nonlinearity is generated in the fV characteristics, the frequency characteristics are imparted to the delay difference of two signals inputted into the EXOR gate 18, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

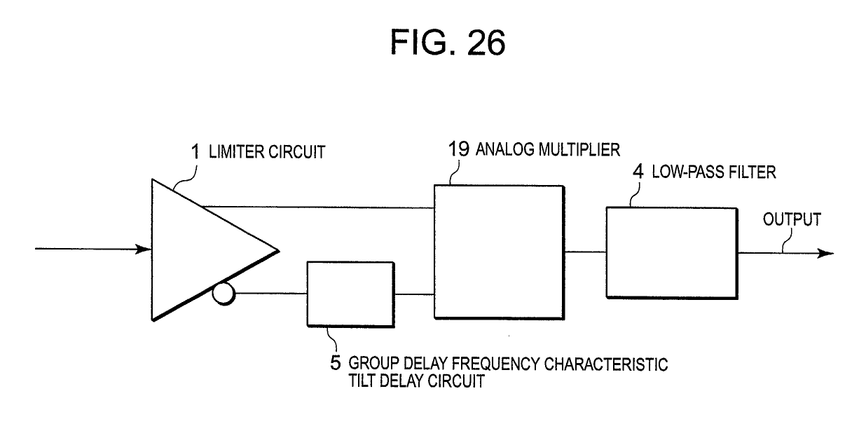

FIG. 26 is a constitution diagram showing a twenty-first embodiment of the FM demodulator according to the present invention. Here, the respects different from those of the FM demodulator of the first embodiment will be described. In the FM demodulator of the twenty-first embodiment, the AND gate 3 which outputs a logical product of the signal outputted from the limiter circuit 1 and the signal delayed by the group delay frequency characteristics tilt delay circuit 5 is replaced with an analog multiplier 19 constituted of a diode mixer, and the like.

An operation of the twenty-first embodiment will next be described. The inputted FM signal is converted to the rectangular wave from the sine wave by the limiter circuit 1 and the reverse and non-reverse signals are outputted. For the outputs of the limiter circuit 1, the non-reversed output is inputted into the analog multiplier 19 as such, and the reversed output of the limiter circuit 1 is inputted into the group delay frequency characteristics tilt delay circuit 5. The group delay frequency characteristics tilt delay circuit 5 has frequency characteristics in the group delay and causes the delay which differs with the frequency. Therefore, the reversed output of the limiter circuit 1 is passed through the group delay frequency characteristics tilt delay circuit 5, thereby has the delay which differs with the frequency, and is inputted into the analog multiplier 19. Similarly as the AND gate 3 of the first embodiment, the analog multiplier 19 outputs a logical product of the output of the limiter circuit 1 and the signal of the group delay frequency characteristics tilt delay circuit 5, and thereby outputs a pulse having the pulse time width in accordance with the delay time difference of two signals inputted into the analog multiplier 19. The output of the analog multiplier 19 is passed through the low-pass filter 4 and the voltage is outputted in accordance with the frequency of the FM signal so that FM demodulation is performed.

Here, in the group delay frequency characteristics tilt delay circuit 5, the delay amount differs with the frequency and the pulse time width outputted from the analog multiplier 19 differs with the frequency. Therefore, when the analog multiplier 19 output has the dragging or undershoot, the nonlinearity is generated in the fV characteristics. In this case, the nonlinearity is imparted to the fV characteristics by the group delay frequency characteristics by the group delay frequency characteristics tilt delay circuit 5, the fV characteristics are inversely corrected, and the linearity is improved.

As described above, according to the twenty-first embodiment, when the pulse of the analog multiplier 19 output has the dragging or undershoot and thereby the nonlinearity is generated in the fV characteristics, the frequency characteristics are imparted to the delay difference of two signals inputted into the analog multiplier 19, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

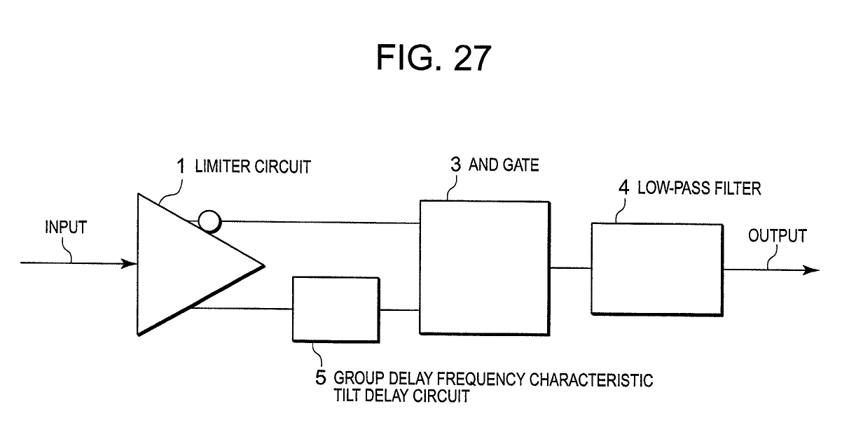

FIG. 27 is a constitution diagram showing a twenty-second embodiment according to the present invention. Here, the respects different from those of the FM demodulator of the first embodiment will be described. The twenty-second embodiment includes a constitution in which the reversed Output of the limiter circuit 1 is directly inputted into the AND gate 3, the non-reversed output of the limiter circuit 1 is inputted into the AND gate 3, and thereby a falling signal of the input signal is detected. Similarly as the first embodiment, when the pulse of the AND gate 3 output has the dragging or undershoot, the nonlinearity is generated in the fV characteristics. In this case, the fV characteristics are imparted to the delay difference of two signals inputted into the AND gate 3, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

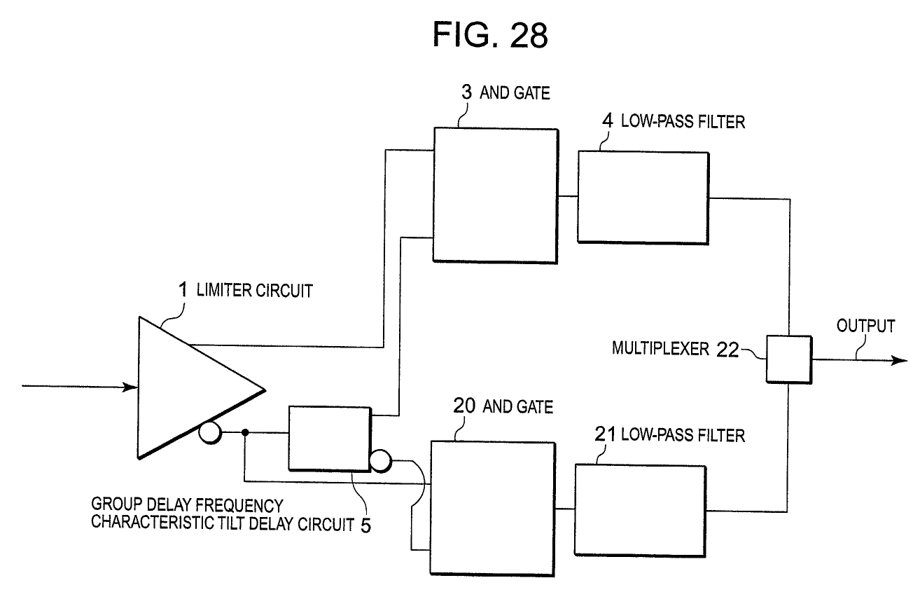

FIG. 28 is a constitution diagram showing a twenty-third embodiment of the present invention. Here, the respects different from those of the FM demodulator of the twenty-second embodiment will be described. In the twenty-third embodiment, in addition to the FM demodulator of the twenty-second embodiment, the FM demodulator includes: an AND gate 20 which outputs the logical product of the reversed signal of the output of the limiter circuit 1 and the reversed signal of the group delay frequency characteristics tilt delay circuit 5; a low-pass filter 21 which obtains a demodulated signal from the output of the AND gate 20; and a multiplexer 22 which combines the outputs of the low-pass filters 4 and 21.

For an operation of the twenty-third embodiment, the respects different from those of the twenty-first embodiment will next be described. In the FM demodulator of the twenty-second embodiment, a rising is detected in the AND gate 3. In the twenty-third embodiment, the AND gate 20 outputs the logical product of the reversed outputs of the limiter circuit 1 and group delay frequency characteristics tilt delay circuit 5, and detects a falling. Both the outputs are passed through the low-pass filters 4 and 21 and combined, and thereby efficiency of the fV characteristics can be raised. Furthermore, similarly as the first embodiment, when the pulses of the outputs of the AND gates 3 and 20 have the dragging or undershoot, the nonlinearity is generated in the fV characteristics. In this case, the fV characteristics are imparted to the delay difference of two signals inputted into the AND gates 3 and 20, and the linearity of the fV characteristics is improved. Thereby, the mutual modulation distortion generated in FM-demodulating the broad-band FM signal into the multi-channel AM image signal or digital image signal is suppressed, and the transmission characteristics can be improved.

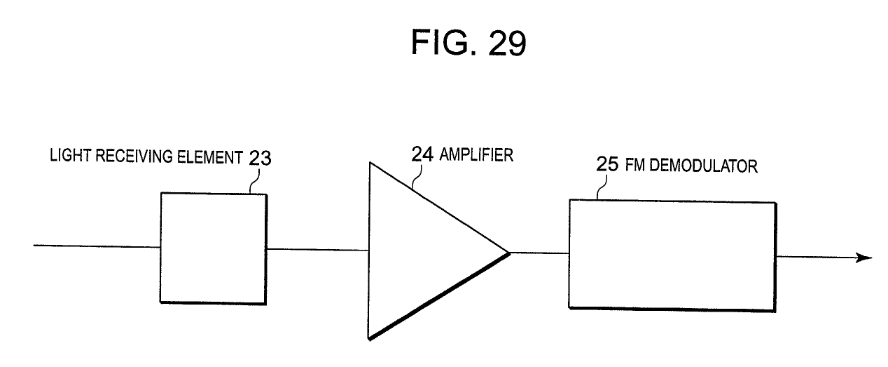

FIG. 29 is a constitution diagram showing a twenty-fourth embodiment according to the present invention. In addition to an FM demodulator 25 described in the first to twenty-third embodiments of the present invention, the twenty-fourth embodiment shows a constitution of an optical receiving apparatus including a light receiving element 23 which converts an optical signal to an electric signal and an amplifier 24.

An operation of the twenty-fourth embodiment will next be described. Here, the FM demodulator has been described in the first to twenty-third embodiments of the present invention. Therefore, in the FM demodulator, the linearity of the fV characteristics is improved. The optical receiving apparatus of the present invention can convert the inputted optical signal to a high-quality AM signal and output the signal.

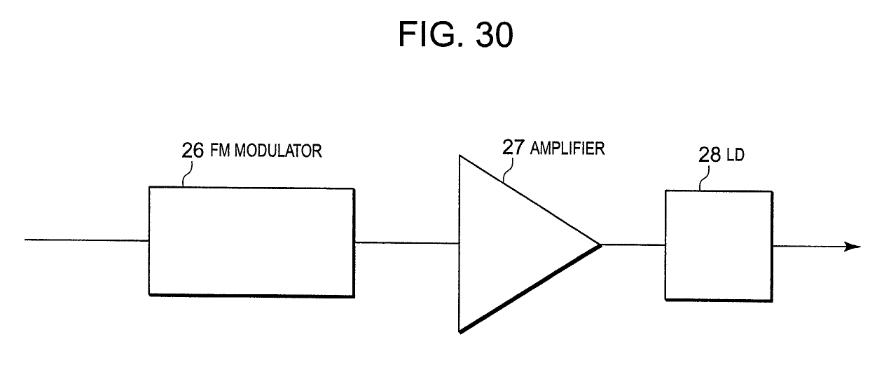

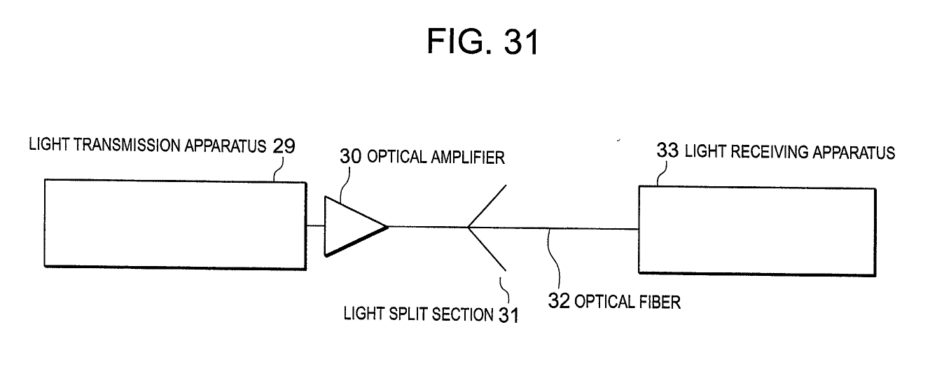

FIG. 30 is a constitution diagram showing an optical transmission apparatus for use in an optical transmission system according to a twenty-fifth embodiment of the present invention. The optical transmission system of the twenty-fifth embodiment will be described later with reference to FIG. 31. The optical transmission apparatus of the optical transmission system includes: an FM modulator 26 which converts an AM signal to an FM signal as shown in FIG. 30; an amplifier 27 which amplifies the FM signal outputted from the FM modulator; and an LD 28 which converts the FM signal outputted from the amplifier 27 to the optical signal.

An operation of the optical transmission apparatus shown in FIG. 30 will next be described. The FM modulator 26 converts the inputted AM signal to the FM signal. The amplifier 27 amplifies the FM signal, and the LD 28 converts the signal to the optical signal. Here, the optical receiving apparatus of the twenty-fourth embodiment is used in the optical receiving apparatus on a reception side with respect to the present optical transmission apparatus, and the FM demodulator described in the first to twenty-first embodiment of the present invention is used in the FM demodulator disposed in the optical receiving apparatus. Therefore, the linearity of the fV characteristics is improved, the optical transmission apparatus and optical receiving apparatus are combined according to the present invention, and thereby the high-quality AM signal can be transmitted. Furthermore, when the nonlinearity is generated in the FM modulator 26 during the FM modulation, and when the linearity of the fV characteristics of the FM demodulator disposed in the optical receiving apparatus is distorted, the FM modulator 26 and FM demodulator cancel the nonlinearity, and thereby the high-quality AM signal can be transmitted.

FIG. 31 is a constitution diagram showing the twenty-fifth embodiment according to the present invention. In the twenty-fifth embodiment, the constitution shown in FIG. 30 is disposed between an optical transmission apparatus 29 and an optical receiving apparatus 33 described in the twenty-fourth embodiment. The constitution includes: an optical amplifier 30 which amplifies the optical signal; a light split section 31 which splits the optical signal into two or more; and an optical fiber 32 which transmits the optical signal.

An operation of the twenty-fifth embodiment will next be described. The optical transmission apparatus 29 converts the AM signal to the FM signal, and then converts the signal to the optical signal. The optical signal outputted from the optical transmission apparatus 29 is amplified by the optical amplifier 30, split by the light split section 31, and transmitted to the optical receiving apparatus 33 via the optical fiber 32. The optical receiving apparatus 33 converts the transmitted optical signal to the electric signal, then FM-demodulates the signal, and outputs the AM signal.

Here, in the optical transmission system, the optical receiving apparatus according to the twenty-fourth embodiment is used in the optical receiving apparatus on the reception side, and the FM demodulator described in the first to twenty-first embodiments of the present invention is used in the FM demodulator disposed in the optical receiving apparatus. Therefore, the linearity of the fV characteristics is improved, the optical transmission apparatus and optical receiving apparatus are combined according to the present invention, and thereby the high-quality AM signal can be transmitted. Furthermore, when the nonlinearity is generated in the FM modulator disposed in the optical transmission apparatus 29 during the FM modulation, and when the linearity of the fV characteristics of the FM demodulator disposed in the optical receiving apparatus is distorted, the FM modulator and FM demodulator cancel the nonlinearity, and thereby the high-quality AM signal can be transmitted.

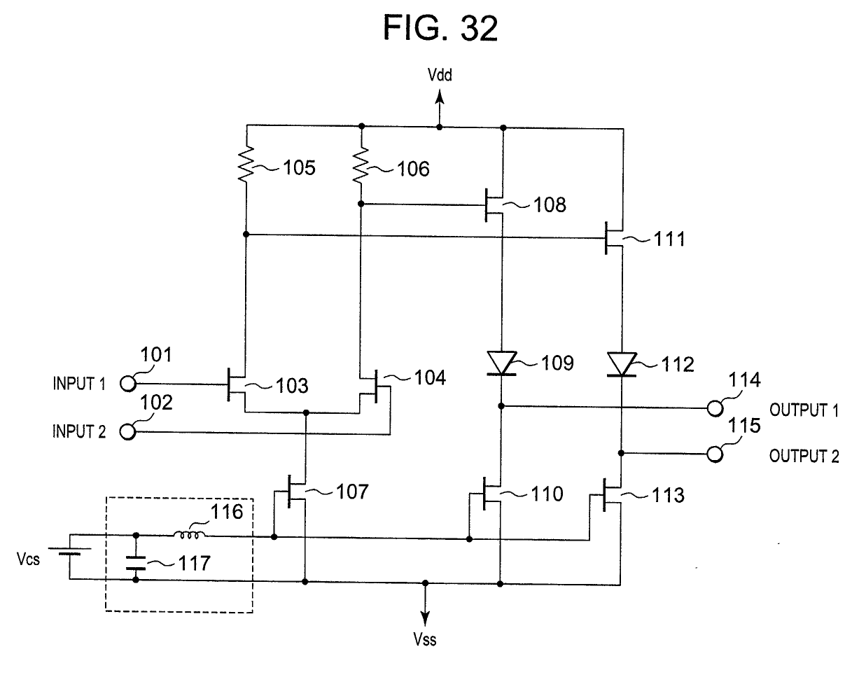

The group delay frequency characteristics tilt delay circuit 5 in the twenty-sixth embodiment will next be described with reference to FIG. 32. The constitution of the example of the group delay frequency characteristics tilt delay circuit 5 shown in FIG. 32 includes a basic differential circuit and source follower. The constitution includes: input terminals 101 and 102 into which the input signals constituting a differential pair are inputted; FET 103 and FET104 whose gates are connected to the input terminals 101,102; load resistors 105,106 which connect drains of the FET103, FET104 to a voltage Vdd on a positive side; an FET107 whose drain is connected to sources of the FET103, FET104 and whose source is connected to a voltage Vss on a negative side; FET111 and FET108 whose gates are connected to the drains of FET103, FET104 and whose drains are connected to Vdd; diodes 109 and 112 connected to the sources of the FET108, FET111; FET110 and FET113 whose drains are connected to the diodes 109,112; and output terminals 114, 115 which output differential outputs via ends of the diodes 109 and 112. A constant voltage Vcs is supplied to the gates of the FET107, FET110, FET113 which function as a constant current drive circuit. This constitution constitutes the differential circuit and source follower. Here, further to impart the frequency characteristics to the group delay, the constitution includes: a coil 116 disposed between a Vcs power source and the gates of the FET107, FET110, FET113; and a capacitor 117 connected between Vcs and Vss.

The group delay frequency characteristics tilt delay circuit 5 in the twenty-sixth embodiment shown in FIG. 32 will be described. Differential signals inputted via the inputs 101,102 are amplified by a differential amplifier including the load resistors 105,106, FET103, FET104, and FET107 as a constant current source, and outputted to the drains of the FET103, FET104. The signal outputted from the drain of the FET103 is passed through the source follower including the FET108, diode 109 for a level shift, and FET110 and outputted to the output 114. The signal outputted from the drain of the FET104 is passed through a buffer by the source follower including the FET111, diode 112 for the level shift, and FET113 and outputted to the output 115. Here, the coil 116 is disposed between the gates of the FET107, FET110, FET113 and Vcs, and further the capacitor 117 is inserted between Vcs and Vss. Thereby, an impedance between the gates of the FET107, FET110, FET113 and Vss is low with a low frequency and high with a high frequency. Therefore, the delay amount in the high frequency is larger than that in the low frequency. Therefore, the frequency characteristics can be imparted to the group delay.

The circuit including the differential circuit and source follower in this manner as shown in FIG. 32 is connected in one stage or in a multiplicity of stages in series. This can realize the group delay frequency characteristics tilt delay circuit 5 in the first, fifth, twentieth, twenty-first, twenty-sixth, twenty-seventh. Moreover, in the connection in the multiple stages, a part can be constituted of the circuit shown in FIG. 32, and a remaining part can be constituted of a usual differential circuit.

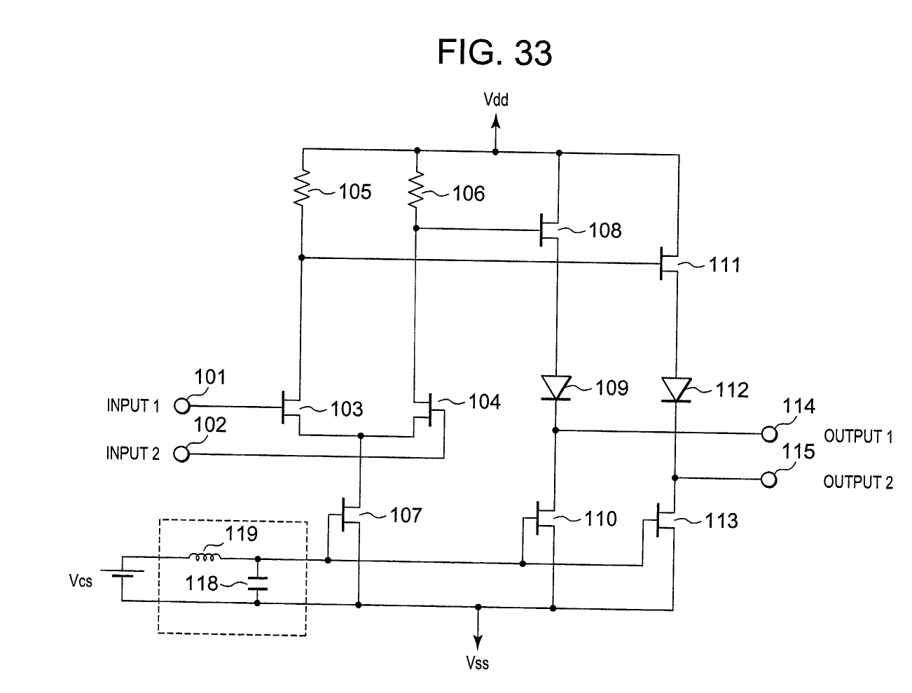

The group delay frequency characteristics tilt delay circuit 5 in a twenty-seventh embodiment will be described with reference to FIG. 33. In place of the coil 116 and capacitor 117 in a dot line of the circuit of FIG. 32, the constitution additionally includes: a coil 119 between Vcs and the gates of the FET107, FET110, FET113; and a capacitor 118 between the gates of the FET107, FET110, FET113 and Vss.

In the circuit for the group delay frequency characteristics tilt delay circuit 5 of FIG. 33, as compared with the circuit of FIG. 32, the coil 119 is disposed between the gates of the FET107, FET110, FET113 and Vcs, and the capacitor 118 is connected to the gates of the FET107, FET110, FET113. Thereby, the impedance between the gates of the FET107, FET110, FET113 and Vss is high with a low frequency and low with a high frequency.

Therefore, the delay amount in the high frequency is smaller than that in the low frequency. Therefore, the circuit can have the tilt of the group delay characteristics reverse to that of the group delay frequency characteristics tilt delay circuit 5 shown in FIG. 32.

Similarly as the circuit of FIG. 32, the circuit including the differential circuit and source follower as shown in FIG. 33 is connected in one stage or in a multiplicity of stages in series. This can realize the group delay frequency characteristics tilt delay circuit in the first, fifth, twentieth, twenty-first, twenty-sixth, twenty-seventh. Moreover, in the connection in the multiple stages, a part can be constituted of the circuit shown in FIG. 33, and the remaining part can be constituted of the usual differential circuit.

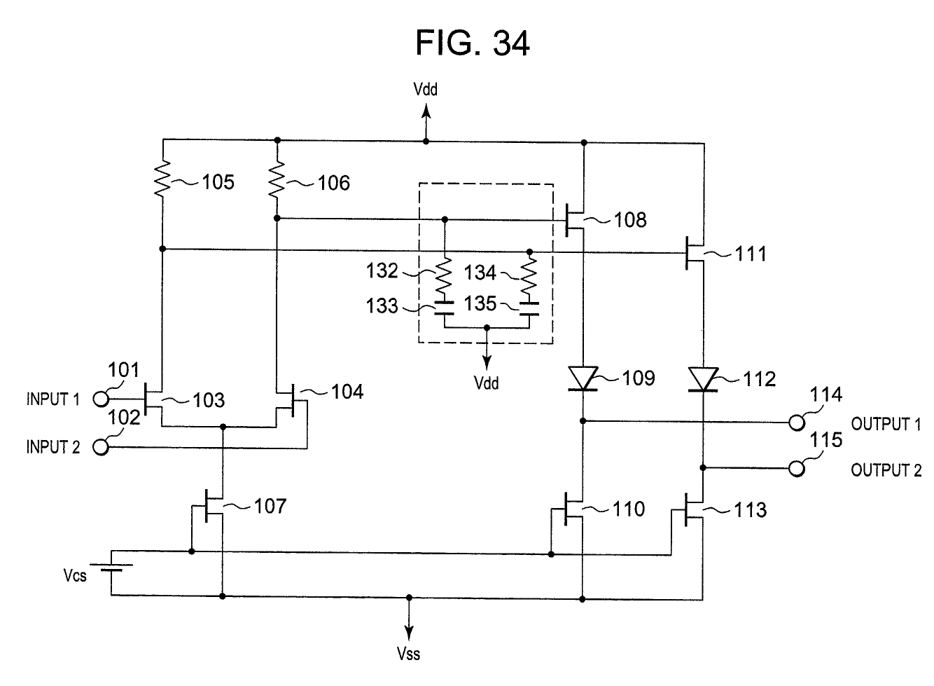

The group delay frequency characteristics tilt delay circuit 5 in a twenty-eighth embodiment will be described with reference to FIG. 34. In the constitution, the coil 116 and capacitor 117 in the dot line of circuit of FIG. 32 are deleted, and Vcs is directly connected to the gates of the FET107, FET110, FET113. Furthermore, a resistor 132 is connected in series to a capacitor 133 between the gate of the FET108 and Vdd (or Vss), and a resistor 134 is connected in series to a capacitor 135 between the gate of the FET111 and Vdd.

In the constitution of FIG. 34, the impedance between the gates of the FET108, FET111 and Vdd (or Vss) is low with the high frequency and high with the low frequency. Therefore, the delay amount in the low frequency is larger than that in the high frequency. Therefore, the frequency characteristics can be imparted to the group delay.

When the circuit including the differential circuit and source follower as shown in FIG. 34 is connected in one stage or in a multiplicity of stages in series, the group delay frequency characteristics tilt delay circuit in the first, fifth, twentieth, twenty-first, twenty-sixth, twenty-seventh can be realized. Moreover, in the connection in the multiple stages, it is also possible to constitute a part by the circuit shown in FIG. 34, and the remaining by the usual differential circuit.

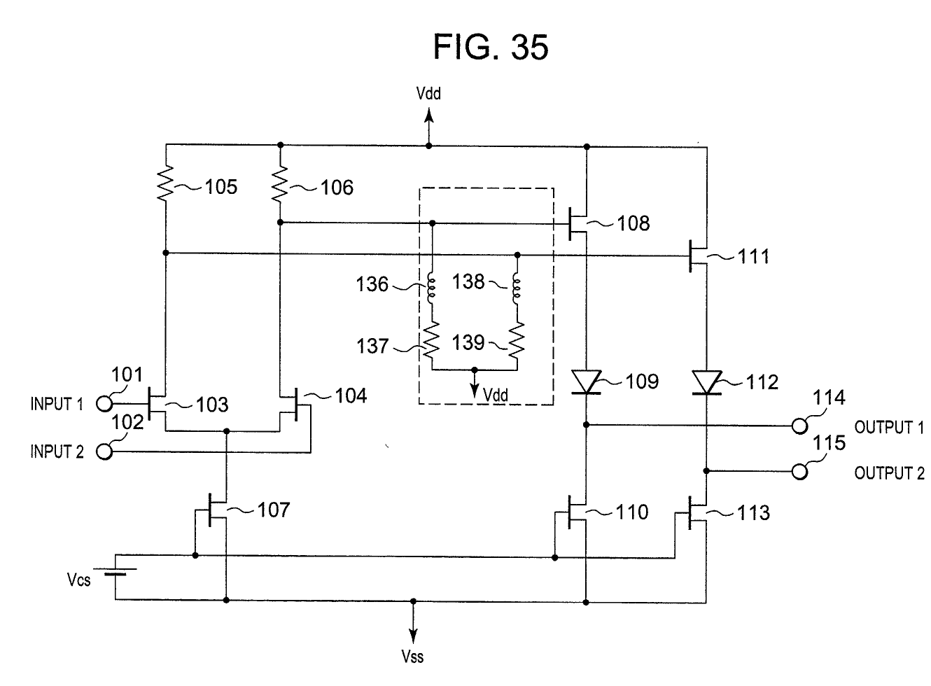

The group delay frequency characteristics tilt delay circuit 5 in a twenty-ninth embodiment will be described with reference to FIG. 35. In the constitution, instead of the resistor 132, capacitor 133, resistor 134, and capacitor 135 in the dot line of the circuit of FIG. 34, a resistor 137 is connected in series to a coil 136 between the gate of the FET108 and Vdd (or Vss), and a resistor 139 is connected in series to a coil 139 between the gate of the FET111 and Vdd (or Vss).

In the constitution of FIG. 35, the impedance between the gates of the FET108, FET111 and Vdd (or Vss) is high with the high frequency and low with the low frequency. Therefore, the delay amount in the high frequency is larger than that in the low frequency. Therefore, the circuit can have the tilt of the group delay characteristics reverse to that of the group delay frequency characteristics tilt delay circuit 5 shown in FIG. 34.

When the circuit including the differential circuit and source follower as shown in FIG. 35 is connected in one stage or in a multiplicity of stages in series, the group delay frequency characteristics tilt delay circuit in the first, fifth, twentieth, twenty-first, twenty-sixth, twenty-seventh can be realized. Moreover, in the connection in the multiple stages, it is also possible to constitute a part by the circuit shown in FIG. 35, and the remaining part by the usual differential circuit.

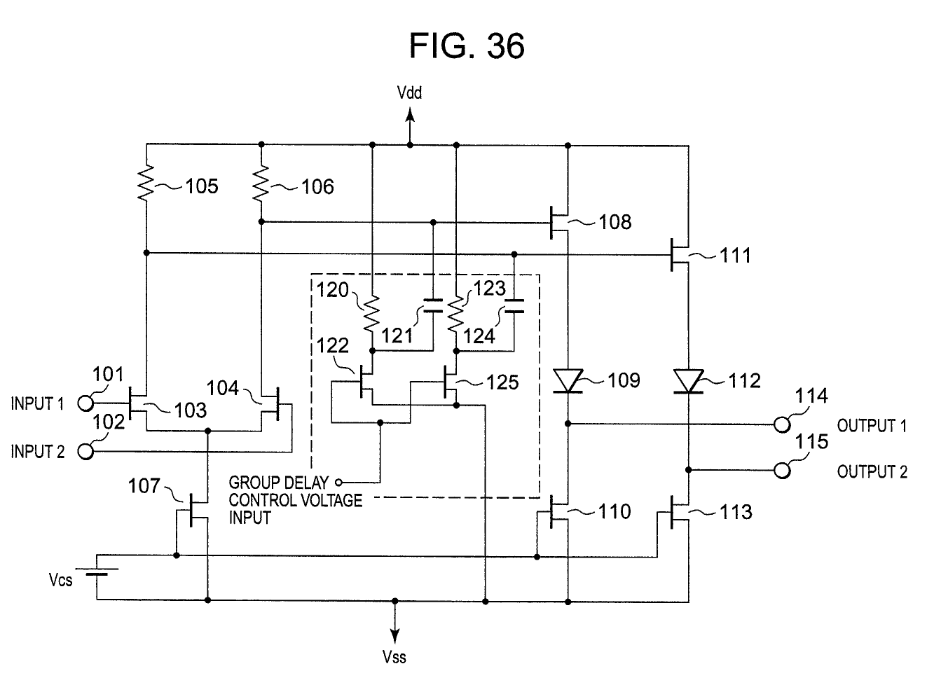

The group delay frequency characteristics tilt amount variable delay circuit 7 in a thirtieth embodiment will be described with reference to FIG. 36. The constitution of the example of the group delay frequency characteristics tilt amount variable delay circuit 7 shown in FIG. 36 includes the basic differential circuit and source follower. The constitution includes: the input terminals 101 and 102 into which the input signals constituting the differential pair are inputted; FET103 and FET104 whose gates are connected to the input terminals 101,102; load resistors 105,106 which connect the drains of the FET103, FET104 to the voltage Vdd on the positive side; FET107 whose drain is connected to the sources of the FET103, FET104 and whose source is connected to the voltage Vss on the negative side; FET111 and FET108 whose gates are connected to the drains of FET103, FET104 and whose drains are connected to Vdd; diodes 109 and 112 connected to the sources of the FET108, FET111; FET110 and FET113 whose drains are connected to the diodes 109,112; and output terminals 114, 115 which output the differential outputs via the ends of the diodes 109 and 112. The constant voltage Vcs is supplied to the gates of the FET107, FET110, FET113 which function as the constant current drive circuit. This constitutes the differential circuit and source follower. Here, further to impart the frequency characteristics to the group delay, the constitution includes: capacitors 121,124 connected to the gates of the FET108, FET111; resistors 120 and 123 which connect the other ends of the capacitors 121, 124 to Vdd; and FET122 and FET 125 whose drains are connected to the resistors 120, 123, whose sources are connected to Vss and whose gates are connected to each other.

An operation of the group delay frequency characteristics tilt amount variable delay circuit 7 of the thirtieth embodiment shown in FIG. 36 will be described. The differential signals inputted via the inputs 101,102 are amplified by the differential amplifier including the load resistors 105,106, FET103, FET104, and FET107 as the constant current source, and outputted to the drains of the FET103, FET104. The signal outputted from the drain of the FET103 is passed through the buffer by the source follower including the FET108, diode 109 for the level shift, and FET110 and outputted to the output 114. The signal outputted from the drain of the FET104 is passed through the buffer by the source follower including the FET111, diode 112 for the level shift, and FET113 and outputted to the output 115. Here, when the gate voltages of the FET122, FET125 are changed, the currents flowing through the FET122 and FET125 change. Therefore, in high-frequency components passed through the capacitors 121, 124, the impedance between the gates of the FET108 and FET111 and Vss is low, when the gate voltages of the FET122 and FET125 are raised. The impedance is high, when the gate voltage is lowered. Therefore, the delay amount of the circuit of FIG. 36 does not change with the low frequency. However, the delay amount is reduced in the high frequency, when the gate voltages of the FET122 and FET125 are raised. The delay amount is increased, when the gate voltages of the FET122 and FET125 are lowered. The frequency characteristics of the delay amount can be changed in this manner.

When the circuit including the differential circuit and source follower in this manner as shown in FIG. 36 is connected in one stage or in a multiplicity of stages in series, the group delay frequency characteristics tilt amount variable delay circuit in the second, third, eleventh, twelfth, thirteenth, fourteenth can be realized. Moreover, in the connection in the multiple stages, a part may also be constituted of the circuit shown in FIG. 36, and the remaining part can be constituted of the usual differential circuit.

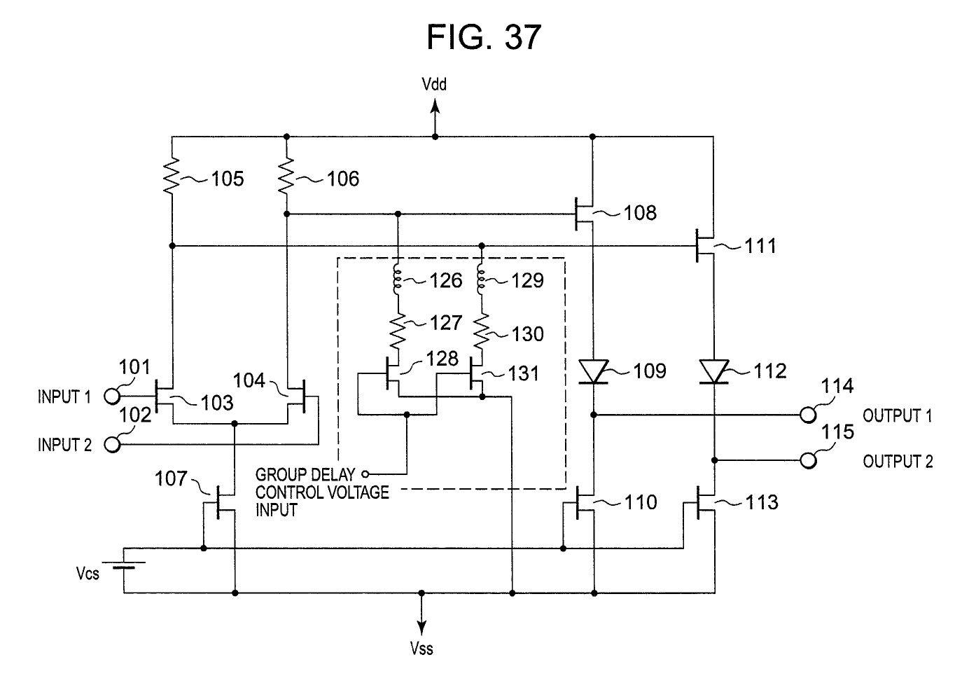

The group delay frequency characteristics tilt amount variable delay circuit 7 in a thirty-first embodiment will be described with reference to FIG. 37. In place of the FET122, FET125, resistors 120,123, and capacitors 121,124 in the dot line of the circuit of FIG. 36, the constitution includes: coils 126 and 129 connected to the gates of the FET108, FET111; resistors 127 and 130 connected to the other ends of the coils 126 and 129; and FET128 and FET131 whose drains are connected to the other ends of the resistors 127, 130, whose sources are connected to Vss and whose gates are connected to each other.

Only the difference of the operation of the group delay frequency characteristics tilt amount variable delay circuit 7 of the thirty-first embodiment shown in FIG. 37 from that of the thirtieth embodiment will be described. When the gate voltages of the FET128 and FET131 are changed, the currents flowing through the FET128 and FET131 change. Therefore, in low-frequency components passed through the coil 126 and capacitor 129, the impedance between the gates of the FET108 and FET111 and Vss is low, when the gate voltages of the FET128 and FET131 are raised. The impedance is high, when the gate voltage is lowered. Therefore, the delay amount of the circuit of FIG. 37 does not change with the high frequency. However, the delay amount is reduced in the low frequency, when the gate voltages of the FET128 and FET131 are raised. The delay amount is increased, when the gate voltages of the FET128 and FET131 are lowered. The frequency characteristics of the delay amount can be changed in this manner.

When the circuit including the differential circuit and source follower as shown in FIG. 37 is connected in one stage or in a multiplicity of stages in series, the group delay frequency characteristics tilt amount variable delay circuit 7 in the second, third, eleventh, twelfth, thirteenth, fourteenth can be realized. Moreover, in the connection in the multiple stages, a part may also be constituted of the circuit shown in FIG. 37, and the remaining part can be constituted of the usual differential circuit.

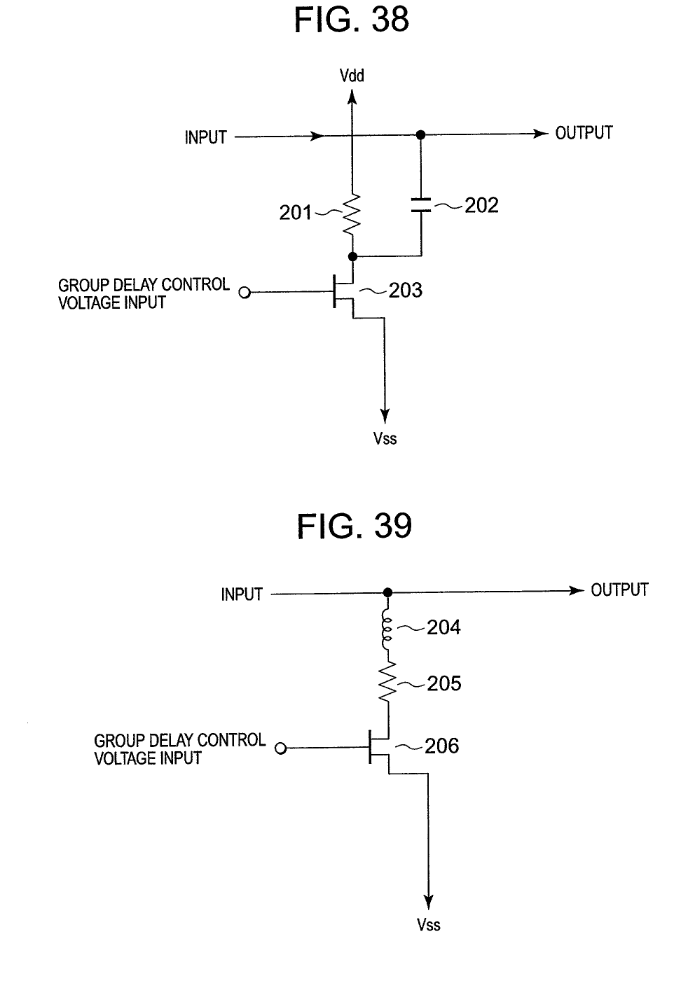

The group delay frequency characteristics tilt amount variable delay circuit 7 in a thirty-second embodiment will be described with reference to FIG. 38. The constitution of the example of the group delay frequency characteristics tilt amount adjustment circuit shown in FIG. 38 includes: a capacitor 202 connected to an input/output line; a resistor 201 which connects the other end of the capacitor 202 to Vdd; and an FET203 whose drain is connected to the resistor 201 and whose source is connected to Vss.

The operation of the group delay frequency characteristics tilt amount adjustment circuit of the thirty-second embodiment shown in FIG. 38 will be described. When the gate voltage of the FET203 is changed, the current flowing through the FET203 changes. Therefore, in the high-frequency components passed through the capacitor 202, the impedance between the input/output line and Vss is low, when the gate voltage of the FET203 is raised. The impedance is high, when the gate voltage is lowered. Therefore, the delay amount of the circuit of FIG. 38 does not change with the low frequency. However, the delay amount is reduced in the high frequency, when the gate voltage of the FET203 is raised. The delay amount is increased, when the gate voltage of the FET203 is lowered. The frequency characteristics of the delay amount can be changed in this manner.

When the circuit shown in FIG. 38 is connected in one stage or in a multiplicity of stages in series, the group delay frequency characteristics tilt amount adjustment circuit in the fifth, sixth, eighth, ninth, twelfth, fourteenth, sixteenth, seventeenth, eighteenth, and nineteenth embodiments can be realized.

The group delay frequency characteristics tilt amount variable delay circuit 7 in a thirty-third embodiment will be described with reference to FIG. 39. The constitution of the example of the group delay frequency characteristics tilt amount adjustment circuit shown in FIG. 39 includes: a coil 204 connected to the input/output line; a resistor 205 connected to the other end of the coil 204; and an FET206 whose drain is connected to the resistor 205 and whose source is connected to Vss.

The operation of the group delay frequency characteristics tilt amount adjustment circuit of the thirty-third embodiment shown in FIG. 39 will be described. When the gate voltage of the FET206 is changed, the current flowing through the FET206 changes. Therefore, in the low-frequency components passed through the coil 204, the impedance between the input/output line and Vss is low, when the gate voltage of the FET206 is raised. The impedance is high, when the gate voltage is lowered. Therefore, the delay amount of the circuit of FIG. 39 does not change with the high frequency. However, the delay amount is reduced in the low frequency, when the gate voltage of the FET203 is raised. The delay amount is increased, when the gate voltage of the FET203 is lowered. The frequency characteristics of the delay amount can be changed in this manner.

When the circuit shown in FIG. 39 is connected in one stage or in a multiplicity of stages in series, the group delay frequency characteristics tilt amount adjustment circuit in the fifth, sixth, eighth, ninth, twelfth, fourteenth, sixteenth, seventeenth, eighteenth, and nineteenth embodiments can be realized.

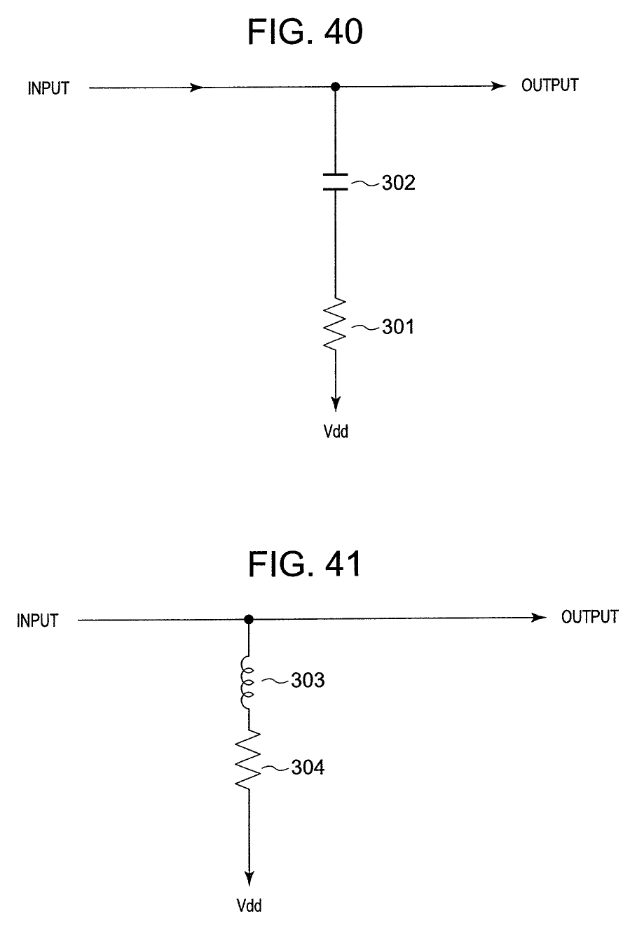

The group delay frequency characteristics tilt circuit in a thirty-fourth embodiment will be described with reference to FIG. 40. The constitution of the example of the group delay frequency characteristics tilt circuit shown in FIG. 40 includes: a capacitor 301 connected to the input/output line; and a resistor 302 which connects the other end of the capacitor 301 to Vdd (or Vss).

The operation of the group delay frequency characteristics tilt circuit of the thirty-fourth embodiment shown in FIG. 40 will be described. In the high-frequency components passed through the capacitor 202, the impedance between the input/output line and Vdd becomes lower similarly as the impedance of the resistor 301. In the low-frequency components, the impedance becomes high. Therefore, the delay amount in the high frequency is smaller than that in the low frequency, and the frequency characteristics of the delay amount can be changed.

When the circuit shown in FIG. 40 is constituted in this manner, the group delay frequency characteristics tilt circuit in the fourth, seventh, tenth, twelfth, thirteenth, fifteenth, sixteenth, and eighteenth embodiments can be realized.

The group delay frequency characteristics tilt circuit in a thirty-fifth embodiment will be described with reference to FIG. 41. The constitution of the example of the group delay frequency characteristics tilt circuit shown in FIG. 41 includes: a coil 303 connected to the input/output line; and a resistor 304 which connects the other end of the coil 303 to Vdd (or Vss).

The operation of the group delay frequency characteristics tilt circuit of the thirty-fifth embodiment shown in FIG. 41 will be described. In the low-frequency components passed through the coil 303, the impedance between the input/output line and Vdd becomes low similarly as the impedance of the resistor 304. In the high-frequency components, the impedance becomes high. Therefore, the delay amount in the high frequency is smaller than that in the low frequency, and the frequency characteristics of the delay amount can be changed.

When the circuit shown in FIG. 41 is constituted in this manner, the group delay frequency characteristics tilt circuit in the fourth, seventh, tenth, twelfth, thirteenth, fifteenth, sixteenth, and eighteenth embodiments can be realized.

As described above, in the FM demodulator of the present invention, when the dragging and undershoot are generated in the AND gate output of the FM demodulator, and thereby the linearity of the fV characteristics is deteriorated, the delay amounts of two signals inputted into the AND gate are changed by the frequency, the fV characteristics are corrected, and thereby the linearity of the fV characteristics of the FM demodulator can be improved. Moreover, for the optical receiving apparatus according to one aspect of the present invention, when the FM demodulator according to another aspect of the present invention is included in the optical receiving apparatus, the high-quality multi-channel image signal having little distortion can be received. Furthermore, in the optical transmission system according to one aspect of the present invention, the optical transmission apparatus is disposed opposite to the optical receiving apparatus of another aspect of the present invention so as to constitute the transmission system. Thereby, the multi-channel image signal can be transmitted with a low distortion.

What is claimed is:

1. A broad-band FM demodulator comprising: a limiter circuit which limits an amplitude of an inputted FM signal and generates pulsed non-reverse and reverse FM signals; a delay circuit which delays one of said reverse and non-reverse FM signals; multiplication means for outputting a logical product of the other of said reverse and non-reverse FM signals and a delayed FM signal as an output of said delay circuit; and a low-pass filter which obtains a demodulated signal from an output of said multiplication means,
wherein tilted frequency characteristics are imparted to group delay of said delay circuit.

2. A broad-band FM demodulator comprising: a limiter circuit which limits an amplitude of an inputted FM signal and generates pulsed non-reverse and reverse FM signals; a delay circuit which delays one of said reverse and non-reverse FM signals; multiplication means for outputting a logical product of the other of said reverse and non-reverse FM signals and a delayed FM signal as an output of said delay circuit; and a low-pass filter which obtains a demodulated signal from an output of said multiplication means, the demodulator further comprising:
a group delay frequency characteristics tilt circuit which imparts tilted frequency characteristics to group delay of the delayed FM signal as the output of said delay circuit, wherein an output of said group delay frequency characteristics tilt circuit is supplied as said delayed FM signal to said multiplication means.

3. A broad-band FM demodulator comprising: a limiter circuit which limits an amplitude of an inputted FM signal and generates pulsed non-reverse and reverse FM signals; a delay circuit which delays one of said reverse and non-reverse FM signals; multiplication means for outputting a logical product of the other of said reverse and non-reverse FM signals and a delayed FM signal as an output of said delay circuit; and a low-pass filter which obtains a demodulated signal from an output of said multiplication means, the demodulator further comprising:
a group delay frequency characteristics tilt circuit which imparts tilted frequency characteristics to group delay of the other of said reverse and non-reverse FM signals, wherein an output of said group delay frequency characteristics tilt circuit is supplied as the other of said reverse and non-reverse FM signals to said multiplication means.

4. A broad-band FM demodulator comprising: a limiter circuit which limits an amplitude of an inputted FM signal and generates pulsed non-reverse and reverse FM signals; a delay circuit which delays one of said reverse and non-reverse FM signals; multiplication means for outputting a logical product of the other of said reverse and non-reverse FM signals and a delayed FM signal as an output of said delay circuit; and a low-pass filter which obtains a demodulated signal from an output of said multiplication means, the demodulator further comprising:
a group delay frequency characteristics tilt circuit which imparts tilted frequency characteristics to group delay of said delay circuit and to the group delay of the other of said reverse and non-reverse FM signals, wherein an output of said group delay frequency characteristics tilt circuit is supplied as the other of said reverse and non-reverse FM signals to said multiplication means.

5. A broad-band FM demodulator comprising: a limiter circuit which limits an amplitude of an inputted FM signal and generates pulsed non-reverse and reverse FM signals; a delay circuit which delays one of said reverse and non-reverse FM signals; multiplication means for outputting a logical product of the other of said reverse and non-reverse FM signals and a delayed FM signal as an output of said delay circuit; and a low-pass filter which obtains a demodulated signal from an output of said multiplication means, the demodulator further comprising:
a first group delay frequency characteristics tilt circuit which imparts tilted frequency characteristics to group delay of the other of said reverse and non-reverse FM signals; and a second group delay frequency characteristics tilt circuit which imparts the tilted frequency characteristics to the group delay of said delay circuit, wherein an output of said first group delay frequency characteristics tilt circuit as the other of said reverse and non-reverse FM signals and an output of said second group delay frequency characteristics tilt circuit as said delayed FM signal are supplied to said multiplication means.

6. The broad-band FM demodulator according to any one of claims 1, 3, 4, further comprising: a function of changing the tilt of said tilted frequency characteristics imparted to the group delay of said delay circuit.

7. The broad-band FM demodulator according to claim 6, further comprising:
a band pass filter which extracts a mutual modulation distortion component of a signal outputted from said low-pass filter;
a power detection circuit which detects a level of the mutual modulation distortion component extracted by said band pass filter; and
a control circuit which controls the group delay of said delay circuit so as to minimize said mutual modulation distortion detection level.

8. The broad-band FM demodulator according to claim 2 or 5 further comprising: a function of changing the tilt of said tilted frequency characteristics imparted to the group delay of said group delay frequency characteristics tilt circuit which responds to said delayed FM signal.

9. The broad-band FM demodulator according to claim 8, further comprising:
a band pass filter which extracts a mutual modulation distortion component of a signal outputted from said low-pass filter;
a power detection circuit which detects a level of the mutual modulation distortion component extracted by said band pass filter; and
a control circuit which controls the group delay of said group delay frequency characteristics tilt circuit so as to minimize said mutual modulation distortion detection level.

10. The broad-band FM demodulator according to claim 4 or 5, further comprising: a function of changing the tilt of said tilted frequency characteristics imparted to the group delay of said delay circuit; and a function of changing the frequency characteristics of the group delay in said group delay frequency characteristics tilt circuit which responds to the other of said reverse and non-reverse FM signals.

11. The broad-band FM demodulator according to claim 4, further comprising:
a band pass filter which includes a function of changing the tilt of said tilted frequency characteristics imparted to the group delay of said delay circuit, and a function of changing the tilt of the frequency characteristics of the group delay in said group delay frequency characteristics tilt circuit responding to the other of said reverse and non-reverse FM signals and which extracts a mutual modulation distortion component of a signal outputted from said low-pass filter;
a power detection circuit which detects a level of the mutual modulation distortion component extracted by said band pass filter; and
a control circuit which controls the group delay of said delay circuit and the group delay in said group delay frequency characteristics tilt circuit so as to minimize said mutual modulation distortion detection level.

12. The broad-band FM demodulator according to claim 5, further comprising:
a band pass filter which includes a function of changing the tilt of said tilted frequency characteristics imparted to the group delay of said first group delay frequency characteristics tilt circuit responding to said delayed FM signal, and a function of changing the tilt of the frequency characteristics of the group delay in said second group delay frequency characteristics tilt circuit responding to the other of said reverse and non-reverse FM signals and which extracts a mutual modulation distortion component of a signal outputted from said low-pass filter;
a power detection circuit which detects a level of the mutual modulation distortion component extracted by said band pass filter; and
a control circuit which controls the group delay of said first and second group delay frequency characteristics tilt circuits so as to minimize said mutual modulation distortion detection level.

13. The broad-band FM demodulator according to claim 1 or 4 wherein said delay circuit is constituted of a circuit connected in one stage or a multiplicity of stages in series, the circuit including:
first and second input terminals into which input signals constituting a differential pair are inputted;
first and second field-effect transistors whose gates are connected to said first and second input terminals;
first and second load resistors which connect drains of said first and second field-effect transistors to a power source Vdd on a positive side;
a third field-effect transistor whose drain is connected to sources of said first and second field-effect transistors and whose source is connected to a power source Vss on a negative side;
fourth and fifth field-effect transistors whose gates are connected to the drains of said first and second field-effect transistors and whose drains are connected to the power source Vdd on said positive side;
first and second diodes connected to the sources of said fourth and fifth field-effect transistors;
sixth and seventh field-effect transistors whose drains are connected to other ends of said first and second diodes and whose sources are connected to the power source Vss on said negative side;
first and second output terminals which output differential outputs from the other ends of said first and second diodes;
a predetermined power source which supplies a constant voltage to gates of said third, sixth and seventh field-effect transistors serving as a constant current drive circuit;
coils inserted between said predetermined power source and the gates of said third, sixth and seventh field-effect transistors; and
a capacitor connected between said predetermined power source and the power source Vss on said negative side.

14. The broad-band FM demodulator according to claim 1 or 4 wherein the delay circuit is constituted of a circuit connected in one stage or a multiplicity of stages in series, each circuit including:
first and second input terminals into which input signals constituting a differential pair are inputted;
first and second field-effect transistors whose gates are connected to said first and second input terminals;
first and second load resistors which connect drains of said first and second field-effect transistors to a power source Vdd on a positive side;
a third field-effect transistor whose drain is connected to sources of said first and second field-effect transistors and whose source is connected to a power source Vss on a negative side;
fourth and fifth field-effect transistors whose gates are connected to the drains of said first and second field-effect transistors and whose drains are connected to the power source Vdd on said positive side;
first and second diodes connected to the sources of said fourth and fifth field-effect transistors;
sixth and seventh field-effect transistors whose drains are connected to other ends of said first and second diodes and whose sources are connected to the power source Vss on said negative side;
first and second output terminals which output differential outputs from the other ends of said first and second diodes;
a predetermined power source which supplies a constant voltage to gates of said third, sixth and seventh field-effect transistors serving as a constant current drive circuit;
coils inserted between said predetermined power source and the gates of said third, sixth and seventh field-effect transistors; and
a capacitor connected between the gates of said third, sixth and seventh field-effect transistors and the power source Vss on said negative side.

15. The broad-band FM demodulator according to claim 1 or 4 wherein said delay circuit is constituted of a circuit connected in one stage or a multiplicity of stages in series, each circuit including:
first and second input terminals into which input signals constituting a differential pair are inputted;
first and second field-effect transistors whose gates are connected to said first and second input terminals;
first and second load resistors which connect drains of said first and second field-effect transistors to a power source Vdd on a positive side;
a third field-effect transistor whose drain is connected to sources of said first and second field-effect transistors and whose source is connected to a power source Vss on a negative side;
fourth and fifth field-effect transistors whose gates are connected to the drains of said first and second field-effect transistors and whose drains are connected to the power source Vdd on said positive side;
first and second diodes connected to the sources of said fourth and fifth field-effect transistors;
sixth and seventh field-effect transistors whose drains are connected to other ends of said first and second diodes and whose sources are connected to the power source Vss on said negative side;
first and second output terminals which output differential outputs from the other ends of said first and second diodes;
a predetermined power source which supplies a constant voltage to gates of said third, sixth and seventh field-effect transistors serving as a constant current drive circuit;
a series circuit of a third resistor and first capacitor inserted between the gate of said fourth field-effect transistor and the power source Vdd on said positive side or the power source Vss on said negative side; and
a series circuit of a fourth resistor and second capacitor inserted between the gate of said fifth field-effect transistor and the power source Vdd on said positive side or the power source Vss on said negative side.

16. The broad-band FM demodulator according to claim 1 or 4 wherein the delay circuit is constituted of a circuit connected in one stage or a multiplicity of stages in series, each circuit including:
first and second input terminals into which input signals constituting a differential pair are inputted;
first and second field-effect transistors whose gates are connected to said first and second input terminals;
first and second load resistors which connect drains of said first and second field-effect transistors to a power source Vdd on a positive side;
a third field-effect transistor whose drain is connected to sources of said first and second field-effect transistors and whose source is connected to a power source Vss on a negative side;
fourth and fifth field-effect transistors whose gates are connected to the drains of said first and second field-effect transistors and whose drains are connected to the power source Vdd on said positive side;
first and second diodes connected to the sources of said fourth and fifth field-effect transistors;
sixth and seventh field-effect transistors whose drains are connected to other ends of said first and second diodes and whose sources are connected to the power source Vss on said negative side;
first and second output terminals which output differential outputs from the other ends of said first and second diodes;
a predetermined power source which supplies a constant voltage to gates of said third, sixth and seventh field-effect transistors serving as a constant current drive circuit;
a series circuit of a third resistor and first coil inserted between the gate of said fourth field-effect transistor and the power source Vdd on said positive side or the power source Vss on said negative side; and
a series circuit of a fourth resistor and second coil inserted between the gate of said fifth field-effect transistor and the power source Vdd on said positive side or the power source Vss on said negative side.

17. The broad-band FM demodulator according to claim 1 or 4 wherein the delay circuit is constituted of a circuit connected in one stage or a multiplicity of stages in series, each circuit including:
first and second input terminals into which input signals constituting a differential pair are inputted;
first and second field-effect transistors whose gates are connected to said first and second input terminals;
first and second load resistors which connect drains of said first and second field-effect transistors to a power source Vdd on a positive side;
a third field-effect transistor whose drain is connected to sources of said first and second field-effect transistors and whose source is connected to a power source Vss on a negative side;
fourth and fifth field-effect transistors whose gates are connected to the drains of said first and second field-effect transistors and whose drains are connected to the power source Vdd on said positive side;
first and second diodes connected to the sources of said fourth and fifth field-effect transistors;
sixth and seventh field-effect transistors whose drains are connected to other ends of said first and second diodes and whose sources are connected to the power source Vss on said negative side;
first and second output terminals which output differential outputs from the other ends of said first and second diodes;
a predetermined power source which supplies a constant voltage to gates of said third, sixth and seventh field-effect transistors serving as a constant current drive circuit;
first and second capacitors whose ends are connected to gates of said fourth and fifth field-effect transistors;
third and fourth resistors inserted between the other ends of said first and second capacitors and said positive-side power source Vdd; and
eighth and ninth field-effect transistors whose drains are connected to said third and fourth resistors, whose sources are connected to said negative-side power source Vss and whose gates are connected to each other.

18. The broad-band FM demodulator according to claim 1 or 4 wherein said delay circuit is constituted of a circuit connected in one stage or a multiplicity of stages in series, each circuit including:
first and second input terminals into which input signals constituting a differential pair are inputted;
first and second field-effect transistors whose gates are connected to said first and second input terminals;
first and second load resistors which connect drains of said first and second field-effect transistors to a power source Vdd on a positive side;
a third field-effect transistor whose drain is connected to sources of said first and second field-effect transistors and whose source is connected to a power source Vss on a negative side;
fourth and fifth field-effect transistors whose gates are connected to the drains of said first and second field-effect transistors and whose drains are connected to the power source Vdd on said positive side;
first and second diodes connected to the sources of said fourth and fifth field-effect transistors;
sixth and seventh field-effect transistors whose drains are connected to other ends of said first and second diodes and whose sources are connected to the power source Vss on said negative side;
first and second output terminals which output differential outputs from the other ends of said first and second diodes;
a predetermined power source which supplies a constant voltage to gates of said third, sixth and seventh field-effect transistors serving as a constant current drive circuit;
a series circuit of a first coil and third resistor and a series circuit of a second coil and fourth resistor whose ends are connected to the gates of said he fourth and fifth field-effect transistors; and
eighth and ninth field-effect transistors whose drains are connected to the other ends of the series circuit of said first coil and third resistor and the series circuit of said second coil and fourth resistor, whose sources are connected to said negative-side power source Vss and whose gates are connected to each other.

19. The broad-band FM demodulator according to any one of claims 2 to 5 wherein said group delay frequency characteristics tilt circuit to impart frequency characteristics in which a frequency characteristics curve of said group delay is tilted and to supply a control voltage to a gate of said field-effect transistor so that said tilted frequency characteristics can be changed is realized by a circuit connected in one stage or a multiplicity of stages in series, each circuit including:
a capacitor whose one end is connected to a signal transmission line between an input and output;
a field-effect transistor whose drain is connected to the other end of the capacitor and whose source is connected to a power source Vss on a negative side; and
a resistor inserted between the drain of the field-effect transistor and a power source Vdd on a positive side.

20. The broad-band FM demodulator according to any one of claims 2 to 5 wherein said group delay frequency characteristics tilt circuit to impart frequency characteristics in which a frequency characteristics curve of said group delay is tilted and to supply a control voltage to a gate of said field-effect transistor so that said tilted frequency characteristics can be changed is realized by a circuit connected in one stage or a multiplicity of stages in series, each circuit including:
a series circuit of a coil and resistor, whose one end is connected to a signal transmission line between an input and output; and
a field-effect transistor whose drain is connected to the other end of the series circuit of said coil and resistor and whose source is connected to a power source Vss on a negative side.

21. The broad-band FM demodulator according to any one of claims 2 to 5 wherein said group delay frequency characteristics tilt circuit is realized by a circuit connected in one stage or a multiplicity of stages in series, each circuit including: a series circuit of a capacitor and resistor inserted between a signal transmission line between an input and output and a power source Vdd on a positive side or a power source Vss on a negative side.

22. The broad-band FM demodulator according to any one of claims 2 to 5 wherein said group delay frequency characteristics tilt circuit is realized by a circuit connected in one stage or a multiplicity of stages in series, each circuit including: a series circuit of a coil and resistor inserted between a signal transmission line between an input and output and a power source Vdd on a positive side or a power source Vss on a negative side.

23. The broad-band FM demodulator according to any one of claims 1 to 5 and 13 to 22 wherein any one of an AND gate, EXOR gate, and analog multiplier is used in said multiplication means.

24. The broad-band FM demodulator according to any one of claims 1 to 5 and 13 to 22, further comprising:
second multiplication means which outputs a logical product of a pulsed FM signal of reverse of said limiter circuit output and a reverse signal of the delayed FM signal of said delay circuit output;
a second low-pass filter which obtains a demodulated signal from the output of said second multiplication means; and
a multiplexer which combines outputs of said first and second low-pass filters,
wherein tilted frequency characteristics are imparted to the group delay of said delay circuit.

25. The broad-band FM demodulator according to any one of claims 1 to 5 and 13 to 22 wherein any one of said limiter circuit, delay circuit, and multiplication means includes a differential circuit.

26. The broad-band FM demodulator according to any one of claims 1 to 5 and 13 to 22 wherein said respective circuits and constituting elements are integrated in the same chip.

27. An optical receiving apparatus comprising:
the broad-band FM demodulator according to any one of claims 1 to 5 and 13 to 22;
a light receiving element which converts a received optical signal to an electric signal; and
an amplifier which amplifies the signal outputted from said light receiving element and supplies the signal to said broad-band FM demodulator.

28. An optical receiving apparatus wherein said amplifier and broad-band FM demodulator are integrated in the same chip.

29. An optical transmission system comprising:
an optical transmission apparatus including an FM modulator which collectively converts a multi-channel image signal to an FM signal, an amplifier which amplifies said FM signal, and an LD which converts an output of said amplifier to an optical signal;
an optical amplifier which amplifies the optical signal outputted from said optical transmission apparatus;
a light split section which splits said amplified optical signal;
an optical fiber which transmits split optical signals; and
an optical receiving apparatus including: a broad-band FM demodulator which includes a limiter circuit to limit an amplitude of an inputted FM signal and generate pulsed non-reverse and reverse FM signals, a delay circuit to delay one of said reverse and non-reverse FM signals, multiplication means for outputting a logical product of the other of said reverse and non-reverse FM signals and a delayed FM signal as an output of said delay circuit, and a low-pass filter which obtains a demodulated signal from an output of said multiplication means and which imparts tilted frequency characteristics to group delay of said delay circuit; a light receiving element which converts a received optical signal to an electric signal; and an amplifier which amplifies the signal outputted from said light receiving element and supplies the signal to said broad-band FM demodulator.

30. An optical transmission system comprising:
an optical transmission apparatus including an FM modulator which collectively converts a multi-channel image signal to an FM signal, an amplifier which amplifies said FM signal, and an LD which converts an output of said amplifier to an optical signal;
an optical amplifier which amplifies the optical signal outputted from said optical transmission apparatus;
a light split section which splits said amplified optical signal;
an optical fiber which transmits split optical signals; and
an optical receiving apparatus including: a broad-band FM demodulator which includes a limiter circuit to limit an amplitude of an inputted FM signal and generate pulsed non-reverse and reverse FM signals, a delay circuit to delay one of said reverse and non-reverse FM signals, multiplication means for outputting a logical product of the other of said reverse and non-reverse FM signals and a delayed FM signal as an output of said delay circuit, and a low-pass filter which obtains a demodulated signal from an output of said multiplication means, which further includes a group delay frequency characteristics tilt circuit to impart tilted frequency characteristics to group delay of the delayed FM signal as the output of said delay circuit and which supplies an output of said group delay frequency characteristics tilt circuit as said delayed FM signal to said multiplication means; a light receiving element which converts a received optical signal to an electric signal; and an amplifier which amplifies the signal outputted from said light receiving element and supplies the signal to said broad-band FM demodulator.

31. An optical transmission system comprising:
an optical transmission apparatus including an FM modulator which collectively converts a multi-channel image signal to an FM signal, an amplifier which amplifies said FM signal, and an LD which converts an output of said amplifier to an optical signal;
an optical amplifier which amplifies the optical signal outputted from said optical transmission apparatus;
a light split section which splits said amplified optical signal;
an optical fiber which transmits split optical signals; and
an optical receiving apparatus including: a broad-band FM demodulator which includes a limiter circuit to limit an amplitude of an inputted FM signal and generate pulsed non-reverse and reverse FM signals, a delay circuit to delay one of said reverse and non-reverse FM signals, multiplication means for outputting a logical product of the other of said reverse and non-reverse FM signals and a delayed FM signal as an output of said delay circuit, and a low-pass filter which obtains a demodulated signal from an output of said multiplication means, which further comprises a group delay frequency characteristics tilt circuit to impart tilted frequency characteristics to group delay of the other of said reverse and non-reverse FM signals and which supplies an output of said group delay frequency characteristics tilt circuit as the other of said reverse and non-reverse FM signals to said multiplication means; a light receiving element which converts a received optical signal to an electric signal; and an amplifier which amplifies the signal outputted from said light receiving element and supplies the signal to said broad-band FM demodulator.

32. An optical transmission system comprising:
an optical transmission apparatus including an FM modulator which collectively converts a multi-channel image signal to an FM signal, an amplifier which amplifies said FM signal, and an LD which converts an output of said amplifier to an optical signal;
an optical amplifier which amplifies the optical signal outputted from said optical transmission apparatus;
a light split section which splits said amplified optical signal;
an optical fiber which transmits split optical signals; and
an optical receiving apparatus including: a broad-band FM demodulator which includes a limiter circuit to limit an amplitude of an inputted FM signal and generate pulsed non-reverse and reverse FM signals, a delay circuit to delay one of said reverse and non-reverse FM signals, multiplication means for outputting a logical product of the other of said reverse and non-reverse FM signals and a delayed FM signal as an output of said delay circuit, and a low-pass filter which obtains a demodulated signal from an output of said multiplication means, which further comprises a group delay frequency characteristics tilt circuit to impart tilted frequency characteristics to group delay of said delay circuit and to the group delay of the other of said reverse and non-reverse FM signals and which supplies an output of said group delay frequency characteristics tilt circuit as the other of said reverse and non-reverse FM signals to said multiplication means; a light receiving element which converts a received optical signal to an electric signal; and an amplifier which amplifies the signal outputted from said light receiving element and supplies the signal to said broad-band FM demodulator.

33. An optical transmission system comprising:
an optical transmission apparatus including an FM modulator which collectively converts a multi-channel image signal to an FM signal, an amplifier which amplifies said FM signal, and an LD which converts an output of said amplifier to an optical signal;
an optical amplifier which amplifies the optical signal outputted from said optical transmission apparatus;
a light split section which splits said amplified optical signal;
an optical fiber which transmits split optical signals; and
an optical receiving apparatus including: a broad-band FM demodulator which includes a limiter circuit to limit an amplitude of an inputted FM signal and generate pulsed non-reverse and reverse FM signals, a delay circuit to delay one of said reverse and non-reverse FM signals, multiplication means for outputting a logical product of the other of said reverse and non-reverse FM signals and a delayed FM signal as an output of said delay circuit, and a low-pass filter which obtains a demodulated signal from an output of said multiplication means, which further comprises a first group delay frequency characteristics tilt circuit to impart tilted frequency characteristics to group delay of the other of said reverse and non-reverse FM signals, and a second group delay frequency characteristics tilt circuit to impart the tilted frequency characteristics to the group delay of said delay circuit and which supplies an output of said first group delay frequency characteristics tilt circuit as the other of said reverse and non-reverse FM signals and an output of said second group delay frequency characteristics tilt circuit as said delayed FM signal to said multiplication means; a light receiving element which converts a received optical signal to an electric signal; and an amplifier which amplifies the signal outputted from said light receiving element and supplies the signal to said broad-band FM demodulator.
